(19) United States
(12) Patent Application Publication
(10) Pub. No.: US 2016/0173686 A1
(43) Pub. Date: Jun. 16, 2016

(54) METHOD, SYSTEM AND ELECTRONIC DEVICE FOR REMOTELY RECORDING AND AUTHENTICATING ASSOCIATED RECORDED FILES

(71) Applicant: HOPE BAY TECHNOLOGIES, INC., TAIPEI (TW)

(72) Inventor: BEN-CHIAO JAI, NEIHU DIST. TAIPEI CITY (TW)

(21) Appl. No.: 15/052,904

(22) Filed: Feb. 25, 2016

Related U.S. Application Data
(63) Continuation of application No. 14/029,411, filed on Sep. 17, 2013.

(51) Int. Cl. H04M 3/42; H04M 3/51; H04M 7/00

(52) U.S. Cl. CPC H04M 3/42221; H04M 7/0057; H04M 3/5175

(57) ABSTRACT

The present disclosure provides a method and a system for remotely recording and managing the recorded files, especially for providing such cloud services via a network system, especially a telecommunication system. Images, voices, videos or other data sensed from the environment will be received from an electronic device, transmitted to a remote server and recorded as a file in the server. The recorded file can be retrieved by generating a unique address for the recorded file and sending the unique address to the electronic device or any other assigned address. Any computer can download the recorded file by visiting the aforementioned unique address. Therefore, a cloud based service of remote recording and managing recorded files is provided in the present disclosure. In addition, mechanisms for registration and payment of the aforementioned service are also provided in the present disclosure.

### CROSS-REFERENCE TO RELATED APPLICATIONS

The present application is a continuation in part application of US patent publication no. US20150036807 (application Ser. No. 14/029,411), entitled “Methods and Systems for Remotely Recording and Managing Associated Recorded Files & Electronic Devices”, filed on Sep. 17, 2013, which claims priority of U.S. provisional patent application No. 61/861,405, filed on Aug. 2, 2013.

### FIELD OF THE INVENTION

The present invention relates generally to a method and a system for remotely recording and managing the recorded files, especially for providing such cloud services via network systems, such as wireless local networks or telecommunication systems. The method may be used on any electronic devices that have video or audio receiving functions and functions for connecting to the Internet, especially for electronic devices having telephone, voice over Internet protocol (VoIP) or remote video conference functions. More specifically, the present invention relates to a method and a system for a mobile phone recording voices via a telephone call and managing the recorded voices via short message service (SMS), voice operating control over telephone call or the Internet.

### BACKGROUND OF THE INVENTION

Conventionally, people may use digital voice recorder for recording voices and video recorder for recording images or videos.

However, such devices may not be available or appropriate in some occasions, especially for recording conversations or meetings and using the recorded files as evidences. The recorders and recorded files downloaded from the recorder may be discovered and destroyed. In addition, once an accident occurs to the owner of the recorded files, the recorded files as evidences may never be discovered. Moreover, it is possible for the recorded files downloaded from the recorder being altered or challenged for being altered.

Moreover, the recorded files may be quite large. The user may need frequently downloading recorded files from the recorder to preserve storage for newly recorded files. It is also not convenient for a user to manage recorded files in a plurality of recorders. The user may need frequently downloading recorded files from the recorders and uploading the downloaded files onto a management server.

According to the above, what is needed is a method or a system using such method for resolving the issue of occasions not applicable to recorders and the issues of inconvenience of managing recorded files. Therefore, any electronic devices that have implemented with the aforementioned system may provide an alternative to digital recorders for recording voices or videos, and the system may provide a centralization of management of the recorded files. As a result, an alternative for recording and managing recorded files may be provided.

### BRIEF SUMMARY OF THE INVENTION

The invention provides a method for remotely recording multimedia contents, such as voices, videos or images, over network systems and providing a cloud-based service for storing, sharing and managing the recorded files. Any electronic devices having multimedia receiving functions and functions for connecting to the Internet implemented with the method of the present invention may remotely record voices or videos and store the recorded files in remote servers over any network systems as a cloud service. The recorded files in the cloud may be downloaded, shared and managed through a web browser on any computing devices. More specifically, the method of the present invention may be implemented on any devices having telephone functions. The portable electronic devices therefore may remotely record voices over telecommunication systems with experiences similar to telephone calls. The recorded files may be stored in a remote server, and the data path of the recorded files and the identification information for downloading the recorded files may be retrieved with short message services. The method includes the steps of receiving a recording command, which may be simply a telephone call, in a server from an electronic device, activating recorder function in the server and receiving recorded data through the electronic device, detecting the disconnection to the electronic device, deactivating the recorder function in the server and storing the recorded data. The method further includes the steps of receiving the identity of the electronic device and a retrieving command, which may be simply a short message with specific characters to specific phone number, in the server from the electronic device, sending the data path of the recording file and the identification information for downloading back to the electronic device.

The invention also provides a system for recording and managing recorded files. A user may utilize the aforementioned method of the present invention to remotely record voices or videos and store the recorded files to the system of the present invention. The user may log into the system with the aforementioned identification information. A user may check, download or share the recorded files through the system of the present invention. The system of the present invention may generate and provide a unique data path, such as a web address, corresponding to each download event or each sharing event of each recorded file while receiving multiple destinations, such as e-mail addresses and cell phone numbers, from the user. The recorded file corresponding to the generated unique data path may be downloaded through the unique data path. The system of the present invention comprises a recorder server for remotely recording voices or videos, a storage server for storing each recorded file and generating a unique data path of a sharing event or a download event of each recorded file, a management server for authenticating the identity of the visitors of the system, sending the generated unique data path to assigned destination addresses and transmitting the specific recorded file corresponding to the unique address to any device that visits the system through the unique data path and request for the specific recorded file.

The invention further provides an electronic device for recording and managing recorded files. The electronic device comprises a processor, a memory, an input module, a multimedia receive module and a communication module for connecting to a server via a network system, wherein the processor electrically connected to the memory, the input module, a multimedia receive module and the communication module and is configured to receive a recording command from user through the input module, establish a connection to the server via the network system through the communication module, continuously receive voices or videos data through the multimedia receive module, send the voices and videos data to the server through the communication module for the server to record the voices and videos. The processor of the electronic device may further be configured to receive a retrieving command for a recorded file from the user through the input module, send the retrieve command to the server and receive a unique data path and a password generated corresponding to the recorded file from the server through the communication module. The user may visit the server through the data path and send the password to the server to download the recorded file.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The accompanying drawings illustrate one or more embodiments of the invention and together with the written description, and serve to explain the principles of the invention. Wherever possible, the same reference numbers are used throughout the drawings to refer to the same or like elements of an embodiment, and wherein:

FIGS. 1A, 1B and 1C are block diagrams of the system having at least an electronic device, a remote recorder and management center, a computer for remote recording, storing, managing, downloading and sharing voices or videos through a network system and the Internet according to some embodiments of the present invention.

FIGS. 2A, 2B, 2C and 2D are flowcharts of the method for remotely recording voices according to one embodiment of the present invention.

FIGS. 3A, 3B and 3C are flowcharts of the method for downloading the recorded files from the recorder and management center according to one embodiment of the present invention.

FIGS. 3D, 3E are flowcharts of the method for registering, logging in the recorder and management center and sending the recorded files to 3^{rd} party's address according to one embodiment of the present invention.

FIG. 3F is a flowchart of the method for configuring the sending mechanism of the recorded files to 3^{rd} party's address according to one embodiment of the present invention.

FIGS. 4A and 4B are flowcharts of the method for remotely recording voices according to one embodiment of the present invention.

FIGS. 4C, 4D and 4E are flowcharts of the method for downloading the recorded files from the recorder and management center according to one embodiment of the present invention.

FIG. 4F is a flowchart of the method for registering for an account in the recorder and management center according to one embodiment of the present invention.

FIG. 4G is a flowchart of the method for prepaying for the credit of an account in the recorder and management center and downloading the recorded files according to one embodiment of the present invention.

FIG. 4H is a flowchart of the method for logging in the recorder and management center, configuring the sending mechanism, authenticating the configuration and sending the recorded files to 3^{rd} party's address according to one embodiment of the present invention.

FIG. 4I is a flowchart of the method for verifying payment for a service of sending a recorded file and sending the recorded files to 3^{rd} party's address according to one embodiment of the present invention.

FIG. 5 is a flowchart of the method for registering an account, prepaying for credits of the account and providing services in the recorder and management center according to one embodiment of the present invention.

FIG. 6 is a block diagram of the electronic device according to one embodiment of the present invention;

FIG. 7 is a block diagram of the client side software (app) according to embodiment of the present invention;

FIGS. 8A and 8B respectively illustrate the authentication process of the present disclosure;

FIGS. 9A and 9B are flowcharts of the authentication process respectively performed by the electronic device 100 and the management server 240 of the present disclosure;

FIG. 9C is a flowchart of downloading process of recorded file with a timestamp performed by the recorder and management center 200 of the present disclosure;

FIG. 10 is a functional block diagram of an electronic device 100 enabling authentication of the present disclosure;

FIG. 11 is a functional block diagram of client side software 600 implemented in the electronic device 100 for enabling anti-fraud authentication of the present disclosure;

FIG. 12 is a functional block diagram of a recorder and management device 1000 of the present disclosure;

In accordance with common practice, the various described features are not drawn to scale and are drawn to emphasize features relevant to the present disclosure. Like reference characters denote like elements throughout the figures and text.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” or “containing” or “contains” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

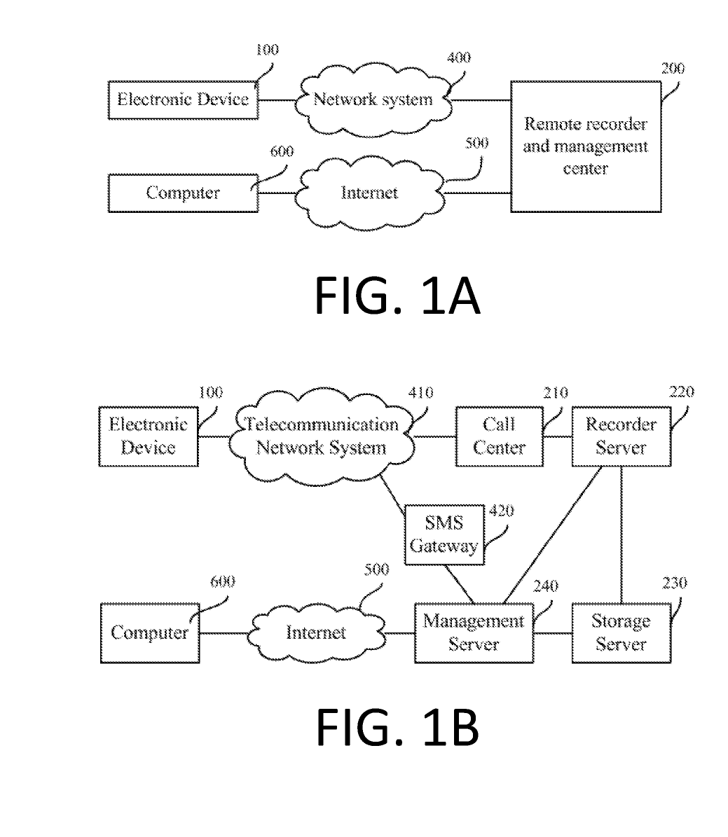

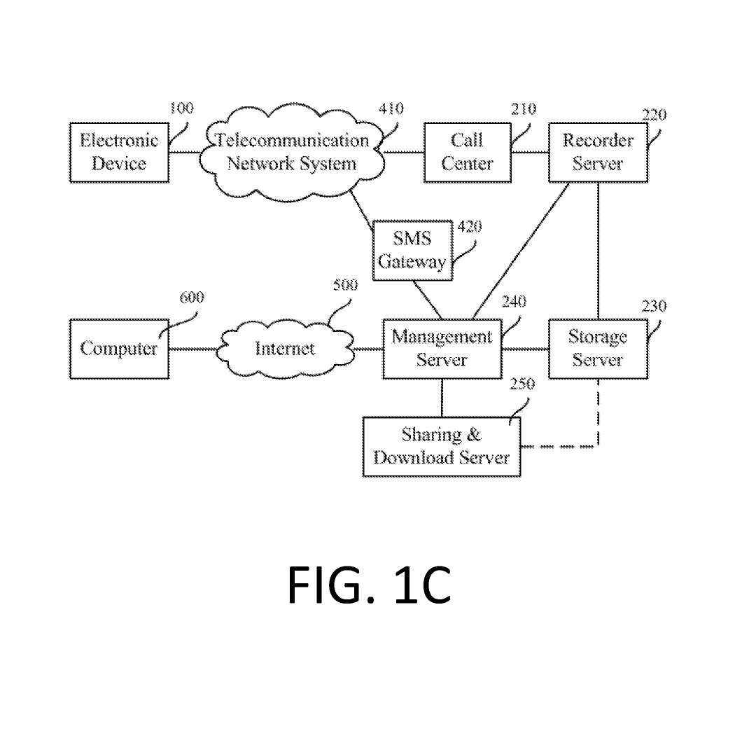

The description will be made as to the embodiments of the present invention in conjunction with the accompanying drawings in FIGS. 1A to 6. Reference will be made to the drawing figures to describe the present invention in detail, wherein depicted elements are not necessarily shown to scale and wherein like or similar elements are designated by same or similar reference numeral through the several views and same or similar terminology.

FIGS. 1A, 1B and 1C illustrate the system for remote recording, storing, managing, downloading and sharing voices or videos according to some embodiments of the present invention.

Referring to FIG. 1A, the electronic device 100 includes voice/image/video receiving function, such as a microphone and/or a camera module. The electronic device 100 also includes a network communication module for connecting to the remote recorder and management center 200 via the network system 400. Therefore, the electronic device 100 may receive images, voices or videos and transmit the received data to the remote recorder and management center 200. Specifically, the electronic device 100 may continuously receive image, voice or video streams and simultaneously transmit the received streaming data to the remote recorder and management center 200. The remote recorder and management center 200 may receive the images, voices, videos and record the data as at least one recorded file upon connecting to the electronic device 100 and store the recorded file once disconnecting with the electronic device 100. Moreover, the remote recorder and management center 200 may generate a unique data path, such as a web address or a uniform resource locater (URL), and unique identification information, such as a password of the recorded file upon receiving the downloading request from the electronic device 100 and send the data path and the identification information to the electronic device 100. The user of the electronic device 100 may utilize any computing device capable of connecting to the internet 500, such as computer 600 to visit the data path and request for the recorded file. The remote recorder and management center 200 may provide the recorded file for downloading to the computer 600 upon receiving the identification information. In addition, the data received and sent by the electronic device 100 may be encrypted during data transmission, and the recorded file may be encrypted and/or compressed by the recorder and management center 200. Therefore, images, voices and videos may be recorded and stored in the remote recorder and management center 200 through the electronic device 100 via the network system 400 and may be retrieved to the computer 600 via internet 500. Specifically, as a result, image/voice/video recording may be provided as a cloud service through electronic devices with multimedia receiving and network connecting functions, which provide more convenience and may be applicable to more occasions than traditional cameras or voice/video recorders.

The electronic device 100 of the present invention may be any communication device with a microphone and/or a camera module, such as a telephone, a mobile phone, a smart phone (smartphone) or a video conference device, wherein the electronic device 100 may perform remote recording through the default communication function such as telephone call or video conference call of the electronic device 100 (as a communication device) or through a programmed software implemented into a the electronic device 100 (as a smart device) such as an application (app) downloaded from an application store (Apple App Store, Google Play . . . etc.). In addition, the electronic device 100 of the present invention may further be any voice/video capturing device or system with communication module such as a web camera, a smart camera, a camcorder, or a surveillance system. Further, the electronic device 100 of the present invention may further be any computer with communication module and a microphone or a camera module, such as a desktop computer, a laptop computer, a tablet computer, a personal digital assistant (PDA) or any smart appliance at home or at office. In one embodiment of the present invention, the electronic device 100 may be multiple non-specific devices connected to the remote recorder and management center 200.

The remote recorder and management center 200 of the present invention may be a server, a server cluster or data center. The network system 400 of the present invention may comprise a wired or wireless local area network, a wide area network, a communication network, a virtual private network or the Internet. More specifically, the network system 400 of the present invention may be a telecommunication system which may comprise a mobile access network, a Public Switched Telephone Network (PSTN) and/or a GPRS core network. Therefore, the network system 400 may provide services such as voice call, short message service, video conference, data transmission in Internet Protocol (IP), instant message and voice/video over IP services. Therefore, the electronic device 100 of the present invention may have a communication module corresponding to the network system 400 for utilizing the networks system 400 to communicate with the remote recorder and management center 200. The communication module of the electronic device 100 of the present invention may be adopting customized protocols or following existing standards or de facto standards such as Ethernet, IEEE 802.11 or IEEE 802.15 series, Wireless USB or telecommunication standards such as PSTN protocol, GSM, IS-95, WCDMA, CDMA2000, TD-SCDMA, IEEE 802.16 (WiMAX) or 3GPP-LTE. In addition, the Internet 500 of the present invention may be any networks available for data transmission from the remote recorder and management center 200. Therefore, a person of ordinary skill in the art may realize that the internet 500 may be a virtual private network, an intranet, a local area network as long as it connects to the remote recorder and management center 200. Similarly, the computer 500 of the present invention may be any computing device available for connecting to the remote recorder and management center 200 via the internet 400, such as a smart phone, a tablet computer, a personal digital assistant (PDA), a laptop computer or a desktop computer.

The electronic device 100 may collect various types of data for recording in and/or uploading to the recorder and management center 200. The aforementioned voices and videos may be only 2 types of the collected data. However, the collected data of the present invention may also comprise other types of data, such as image data receive by a camera, position data receive by a GPS or other sensor data, including but not limited to electronic and magnetic field strength, radiation, temperature, gravity and acceleration, and machinery operation input and status. The aforementioned data may also be collected and sent to the recorder and management center 200 and recorded as a recorded file in a file format corresponding to types of the data.

FIG. 1B illustrates a more specific embodiment of the present invention. Referring to FIG. 1B, the electronic device 100 connects to the call center 210 via the telecommunication network system 410. Therefore, the electronic device 100 may establish a channel between itself and the call center 210 via a voice call, a video conference or voice/video over IP services. Voices or videos may be continuously transmitted to the recorder server 220 via the call center 210. The recorder server 210 may receive the voice or video data and save as a recorded file and transmit the recorded file to the storage server 230 once the call center 210 disconnected from the electronic device 100.

The electronic device 100 may send a short message or an instant message to the call center 210 for retrieving the recorded files. The request may be sent to the management server 240. The management server 240 may request a URL from the storage server 230. The storage server 230 may then generate a unique web address for the request from the management server 240. The management server 240 may generate a unique password for the request and return the URL and the password by short message or instant message via the SMS gateway 420 as a response to the request from the electronic device 100.

The user of the electronic device 100 may visit the URL and send the password for the recorded file through the computer 600 via the internet 500. The management server 240 may retrieve the recorded file from the storage server 230 for downloading to the computer 600. Therefore, voices and videos may be recorded and stored in the remote storage server 230 through the electronic device 100 via the telecommunication network system 410 and may be retrieved to the computer 600 via internet 500. As a result, voice/video recording and managing may be provided as a cloud service through electronic devices with basic telecommunication functions, which provide more convenience and may be applicable to more occasions than traditional voice/video recorders.

FIG. 1C illustrates another more specific embodiment of the present invention. Referring to FIG. 1C, the electronic device 100 connects to the call center 210 via the telecommunication network system 410. Therefore, the electronic device 100 may establish a channel between itself and the call center 210. Voices or videos may be continuously transmitted to the recorder server 220 via the call center 210. The recorder server 210 may receive the voice or video data and save as a recorded file and transmit the recorded file to the storage server 230 once the call center 210 disconnected from the electronic device 100.

The electronic device 100 may request the call center 210 for retrieving the recorded files. The management server 240 may receive a generated URL from the storage server 230 and generate a unique password for the request in response to the request from the electronic device 100.

The user of the electronic device 100 may visit the URL and send the password for the recorded file through the computer 600 via the internet 500. In the embodiment of the present invention in FIG. 1C, the sharing and download server 250 may retrieve the recorded file from the storage server 230 for downloading to the computer 600. Therefore, visits for downloading the recorded files from the computer 600 may be directed to the sharing and download server 250 instead of the management server 240 for security reasons.

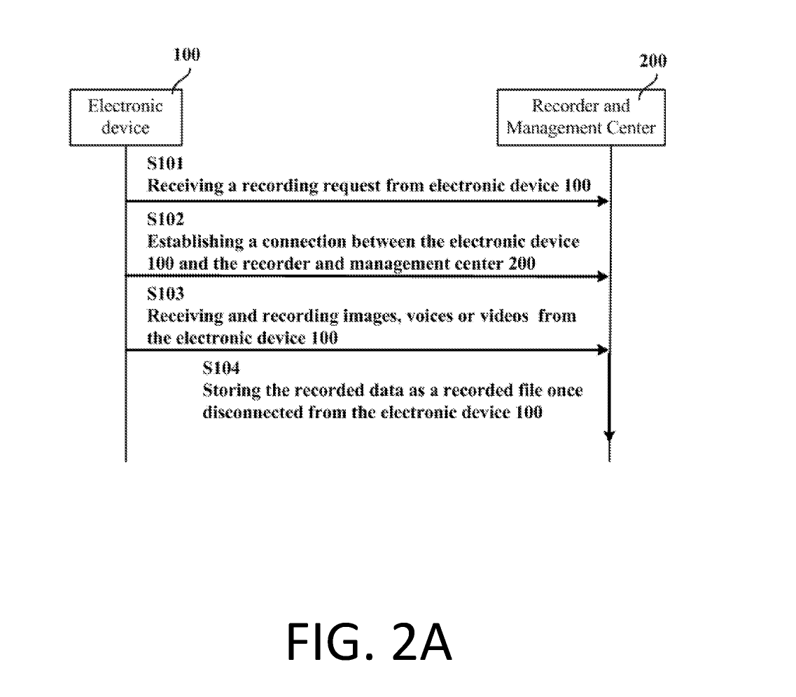

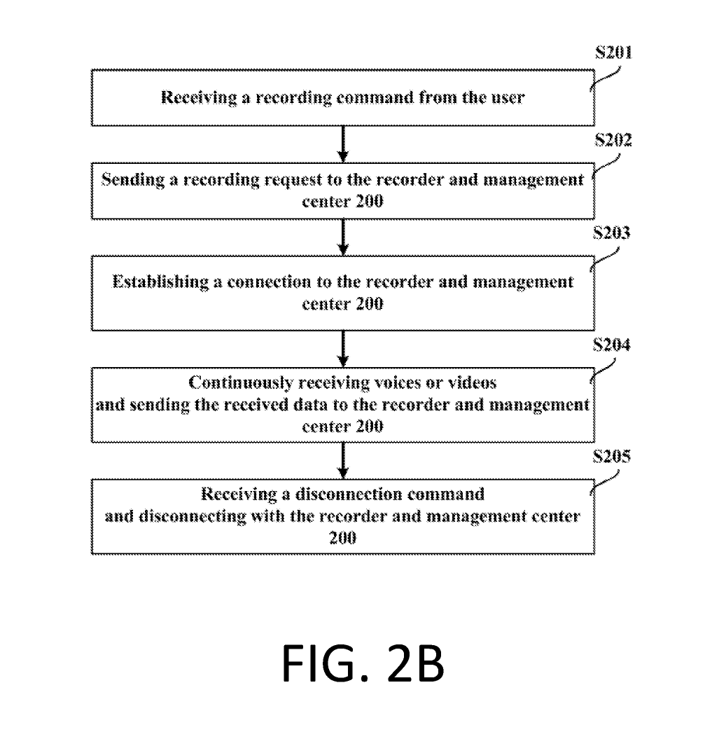

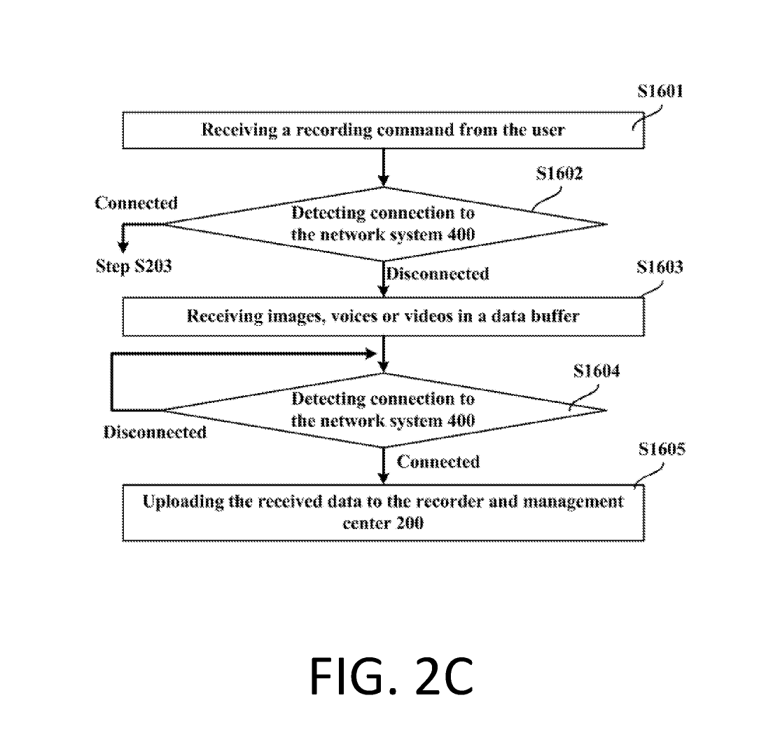

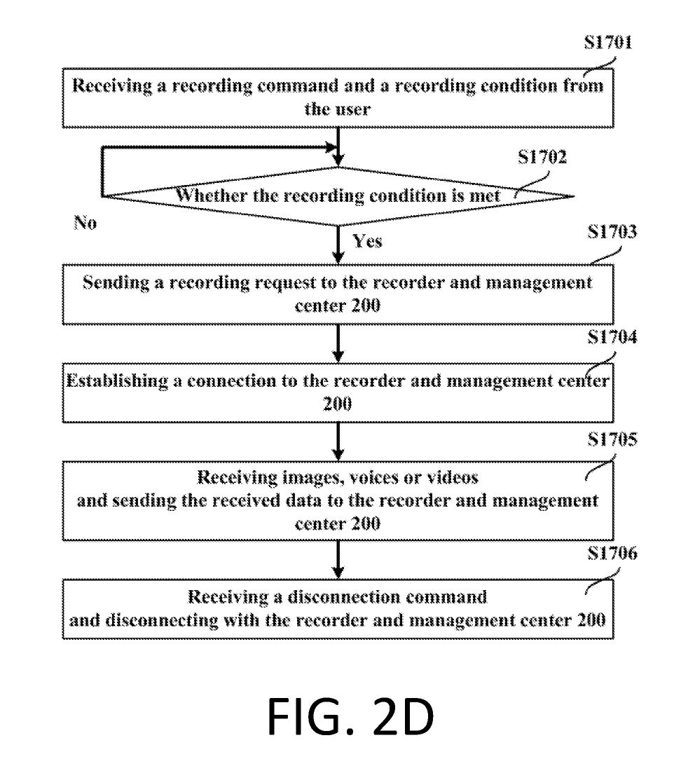

FIGS. 2A, 2B, 2C and 2D are flowcharts illustrating the method for remotely recording images, voices or videos according to one embodiment of the present invention. The method of the present invention may be applied on the electronic device 100 or applied on the recorder and management center 200 of the present invention.

FIG. 2A illustrates the method for recording image, voice or video data in the recorder and management center 200 through the electronic device 100 according to one embodiment of the present invention, and the method of present invention may perform the following steps. In step S101, the recorder and management center 200 receives a recording request from the electronic device 100. In step S102, the recorder and management center 200 and the electronic device 100 may establish a connection between the recorder and management center 200 and the electronic device 100 over the network system 400. In step 103, the recorder and management center 200 may receive image, voice or video data from the electronic device 100 and may record the received data. Specifically, the recorder and management center 200 may receive and record streaming data continuously. In step 104, while the recorder and management center 200 disconnected from the electronic device 100, the recorder and management center 200 may stop recording and store the recorded data as a recorded file. The recorder and management center 200 further compress the recorded data into an audio/video file format or multimedia container format, such as an MP3, AAC, ATRAC, WMA file format for audio data, MPEG-2 Par 2, MPEG-4 Part 2, H.264, RealVideo, VP8 for video data and AVI, MP4, FLV, RealMedia format for both audio and video data.

FIG. 2B illustrates the method for remotely recording images, voices or videos through the electronic device 100 and storing the recorded data in the recorder and management center 200 according to one embodiment of the present invention, and the method of present invention may perform the following steps. In step S201, the electronic device 100 may receive a recording command from the user. The electronic device 100 may comprise an input module for receiving input from the user, such as a keypad, a touch pad, a touch display or a control panel with buttons, wherein the recording command may be represented in the input module as an icon, a key or button, or a combination of specific keys or buttons. Specifically, the recording command may be simply a phone number when the electronic device 100 has telephone function. In step S202, the electronic device 100 may send a recording request corresponding to the received recording command to the recorder and management center 200. The recording request may be message or data transmission over the network system 400. The recording request may also be simply a telephone call over PSTN, mobile network or IP network for recording voices or a video conference call for recording videos. In another embodiment of the present invention, the recording command may be simply an URL directing the electronic device 100 to visit an address provided by the recorder and management center 200 instead of the aforementioned recorder request. In step S203, the electronic device 100 may establish a connection to the recorder and management center 200 over the network system 400. In step S204, the electronic device 100 may receive images, voices or videos and send the received data to the recorder and management center 200. Specifically, the recorder and management center 200 may receive and record streaming data continuously. In step S205, when the user finishes recording, the electronic device 100 may receive a disconnection command and disconnect with the recorder and management center 200. Similarly, the disconnect command may be represented in the aforementioned input module of the electronic device 100 as an icon, a key or button, or a combination of specific keys or buttons. Specifically, the disconnect command may be simply hanging up a phone call when the electronic device 100 has telephone function.

Regarding to the method of present invention in FIG. 2B, in step S201, the recording command may be replaced by an uploading command for uploading a file to the recorder and management center 200, especially for a previously recorded file from the electronic device 100 or an external device connected to the electronic device 100. Thus, in step S202, the electronic device may send an uploading request instead. The electronic device 100 may receive the file and send the received file to the recorder and management center 200 instead of performing steps S203, S204 and S205. Therefore, the recorder and management center 200 may also be able to manage the uploaded files (such as files recorded locally by camera or digital recorders).

FIG. 2C illustrates the method for temporary recording and buffering images, voices or videos in the electronic device 100 without connecting to the network system 400 and uploading the recorded data to the recorder and management center 200 upon connecting to the network system 400 according to one embodiment of the present invention, and the method of present invention may perform the following steps. In step S1601, the electronic device 100 may receive a recording command from the user. In step S1602, the electronic device 100 may detect whether it is connected to the network system 400. If the electronic device is connected to the network system 400, the electronic may perform steps S203, S204 and S205 to record images, voices or videos remotely and store the recorded files to the recorder and management center 200. If the electronic device is not connected to the network system 400, the electronic may perform steps S1603, S1604 and S1605. In step S1603, the electronic device 100 may receive images, voices or videos and temporarily store the received (or recorded) data in a data buffer. In step S1604, the electronic device 100 may periodically detect whether it is connected to the network system 400. While the electronic device 100 connected to the network system 400, in step S1605, the electronic device 100 may upload the received (or recorded file) data to the recorder and management center 200. Therefore, the remote recording may be fulfilled by the electronic device 100 even when the electronic device is temporarily disconnected with any networks. The method illustrated in FIG. 2C may, especially, be implemented as an application (app) provided on online stores for downloading to computers or any smart devices. The computers or smart devices, especially without communication function, may therefore provide remote recording by performing the method of the present invention.

While the methods previously described may include a number of steps that may appear to occur in a specific order, it should be appreciated that these methods may contain more or fewer steps, that the order these steps may be exchanged, and that different steps may be combined. For example, the step S1602 may be omitted.

FIG. 2D illustrates the method for remotely recording images, voices or videos through the electronic device 100 and storing the recorded data in the recorder and management center 200 according to one embodiment of the present invention, and the method of present invention may perform the following steps. In step S1701, the electronic device 100 may receive a recording command and a recording condition from the user. The recording condition may comprise a time for recording, such as starting to record in 1 hour later. In addition, the recording condition may be set according sensor data, such as motion data received by the electronic device 100. Moreover, the recording condition may be a message for the network system to remotely control the electronic device 100 to record. The recording condition may further be configured to record a specific data communication of the electronic device 100, such as recording the next telephone call or video conference call of the electronic device 100.

In step S1702, the electronic device 100 may check whether the recording condition is met. If the recording condition is met, in step S1703, the electronic device 100 may send a recording request corresponding to the received recording command to the recorder and management center 200. In step S1704, the electronic device 100 may establish a connection to the recorder and management center 200 over the network system 400. In step S1705, the electronic device 100 may receive images, voices or videos and send the received data to the recorder and management center 200. Specifically, the recorder and management center 200 may receive and record streaming data continuously. In step S1706, when the user finishes recording, the electronic device 100 may receive a disconnection command and disconnect with the recorder and management center 200. As a result, remotely recording images, voices, videos or other data via the electronic device 100 may be configurable by setting a recording condition in the electronic device 100. Similarly, the recording command in step S1701 may also be replaced by an uploading command for uploading a file to the recorder and management center 200, especially for a previously recorded file. Thus, in steps S1701 and S1702, the aforementioned recording condition may be deemed as an uploading condition. Therefore, in step S1703, the electronic device may send an uploading request instead. The electronic device 100 may receive the file and send the received file to the recorder and management center 200 instead of performing steps S203, S204 and S205. Therefore, the recorder and management center 200 may also be able to manage the uploaded files (such as files recorded locally by digital recorders).

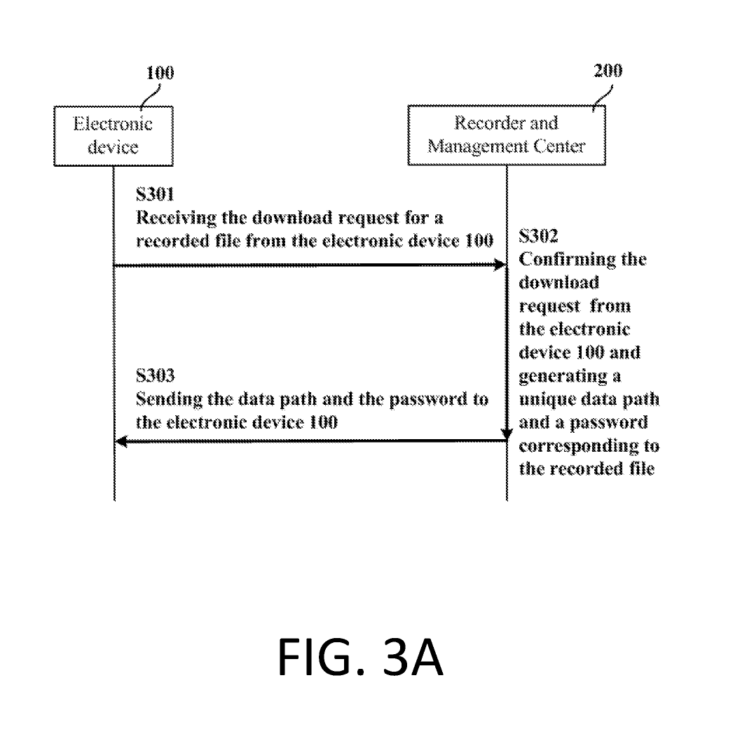

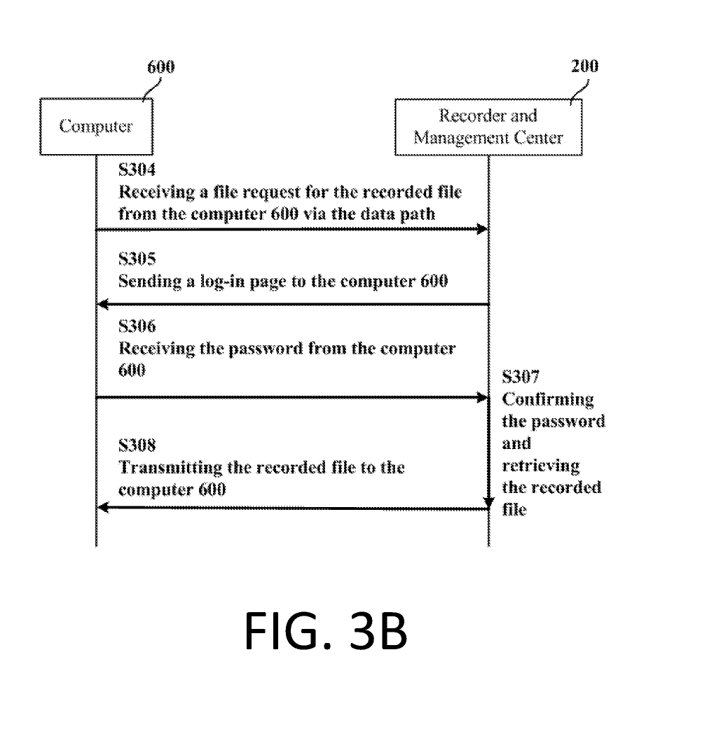

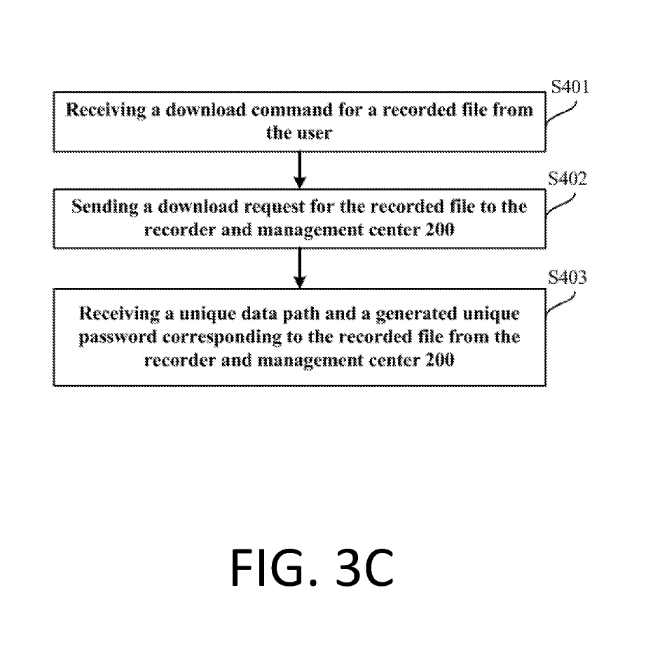

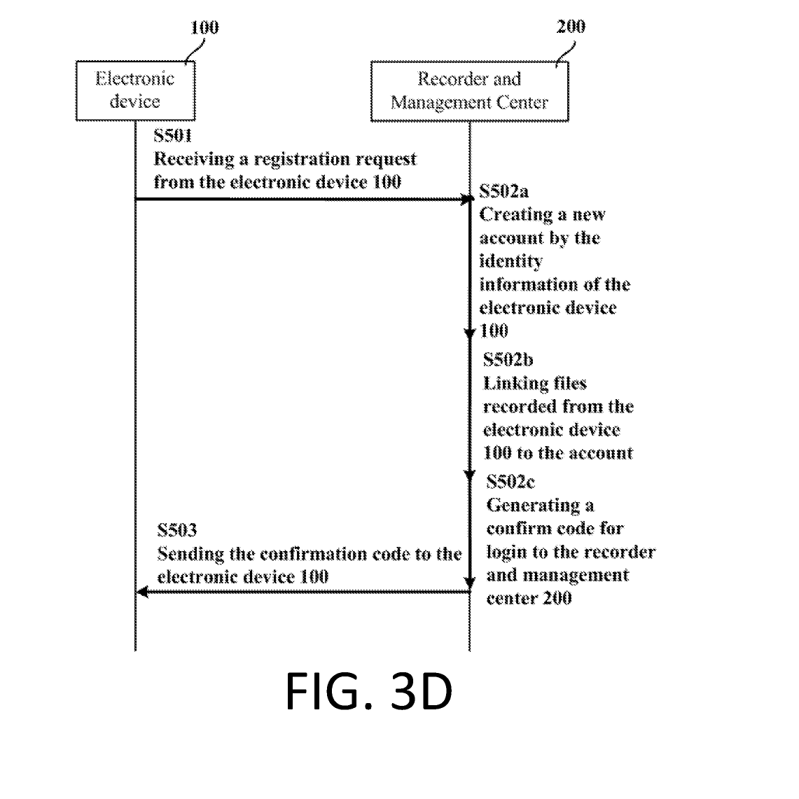

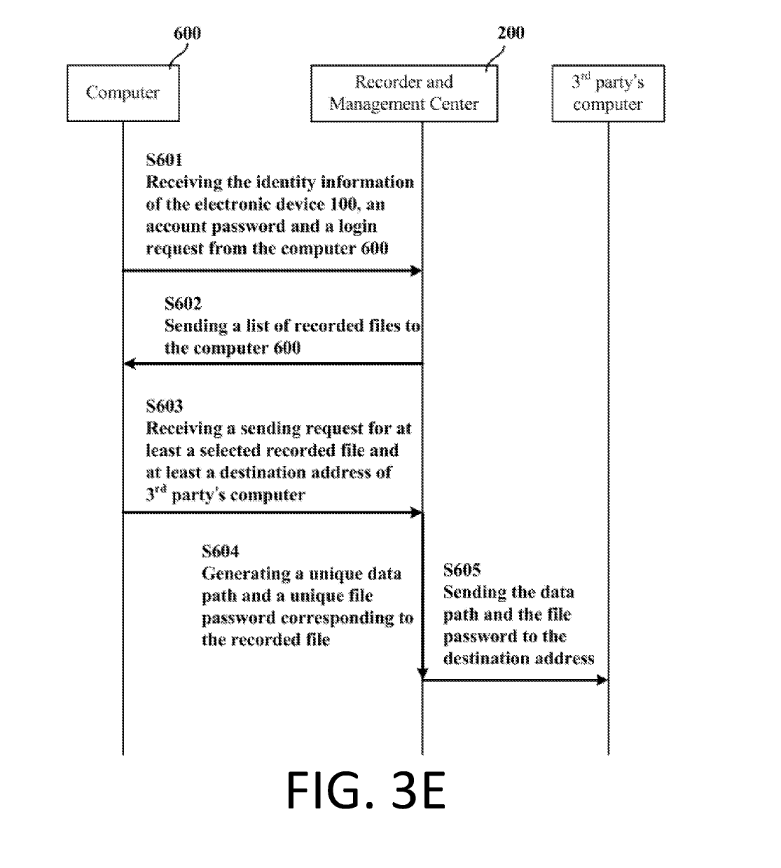

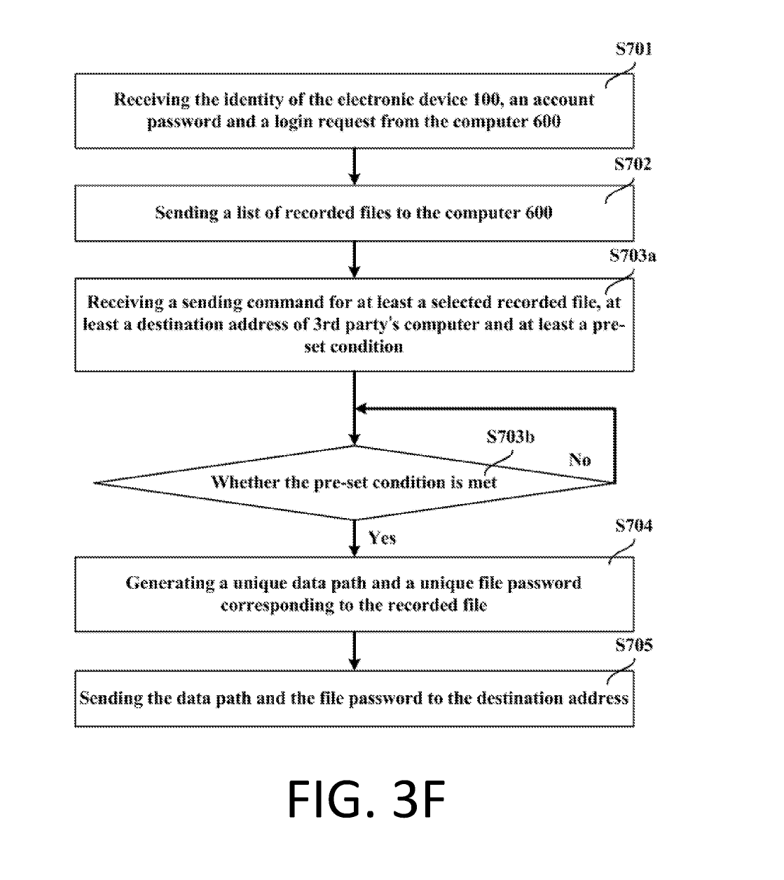

FIGS. 3A to 3F are flowcharts respectively illustrating the method for downloading a recorded file from the recorder and management center 200, registering for an account of the recorder and management center 200, sending a recorded file to 3^{rd} party's address from the recorder and management center 200 and configuring the sending mechanism of a recorded file according to one embodiment of the present invention. The method of the present invention may be applied on the electronic device 100 or applied on the recorder and management center 200 of the present invention.

FIG. 3A illustrates the method for downloading a recorded file from the recorder and management center 200 through the electronic device 100 according to one embodiment of the present invention, and the method of present invention may perform the following steps. In step S301, the recorder and management center 200 may receive a download request for a specific recorded file from the electronic device 100. In step S302, the recorder and management center 200 may confirm the download request from the electronic device 100. The confirmation may be accomplished by receiving identity information of the electronic device 100 before recording, such as the ID, the address of the electronic device. More specifically, the confirmation may be accomplished by checking the phone number of the electronic device 100 if the electronic device 100 has called the recorder and management center 200 for remote recording voices or videos. The recorder and management center 200 may further generate a unique data path and a unique password corresponding to the recorded file. The unique data path and the unique password may further be expired once they have been used to prevent from abuse of the recorded files from people who have the data path and the password later. The number of times, the duration of visits, downloads through the unique data path may further be limited and configured by the user of the electronic device 100. In step S303, the recorder and management center 200 may send the data path and the password to the electronic device 100. The user of the electronic device may download the recorded file by visiting the data path and sending the password to the recorder and management center 200.

FIG. 3B illustrates the method for downloading a recorded file from the recorder and management center 200 through the computer 600 after receiving a data path and a password corresponding to the recorded file according to one embodiment of the present invention, and the method of present invention may perform the following steps. In step S304, the recorder and management center 200 may receive a file request for the recorded file from the computer 600 via the data path. In step S305, the recorder and management center 200 may send a log-in page to the computer 600. In step S306, the recorder and management center 200 may receive the password corresponding to the recorded file from the computer 600. The password may further be corresponding to the data path, that is, the password may not be applicable for a file request from another data path for even the same recorded file. In step S307, the recorder and management center 200 may confirm the password and retrieve the recorded file for downloading to the computer 600. In step 308, the recorder and management center 200 may transmit the recorded file to the computer 600. The recorded file may be transmitted to the computer 600 and saved as a file, or be transmitted as a streaming multimedia to be played on the computer 600.

FIG. 3C illustrates the method for downloading a recorded file through electronic device 100 from the recorder and management center 200 according to one embodiment of the present invention, and the method of present invention may perform the following steps. In step S401, the electronic device 100 may receive a download command for the recorded file from the user. In step S402, the electronic device 100 may send a download request for the recorded file to the recorder and management center 200. In step S403, the electronic device 100 may receive a unique data path and a unique password generated corresponding to the recorded file from the recorder and management center 200. The user of the electronic device may download the recorded file by visiting the data path and sending the password to the recorder and management center 200, as described in the method referring the FIG. 3B.

FIG. 3D illustrates the method for registering an account in the recorder and management center 200 after recording voices or videos for downloading or managing the recorded files according to one embodiment of the present invention, and the method of present invention may perform the following steps. In step S501, the recorder and management center 200 may receive a registration request for an account from the electronic device 100. In step S502a, the recorder and management center 200 may create a new account by the identity information of the electronic device 100, such as the ID, the address of the electronic device. More specifically, the identity information may be the phone number of the electronic device 100 if the electronic device 100 transmits the download request by a short message service, a phone call with voice-operating control or other telecommunication services. In step S502b, the recorder and management center 200 may link files recorded from the electronic device 100 to the account for providing the user the recorded files after the user logs in. In step S502c, the recorder and management center 200 may generate a confirmation (confirm) code for login to the recorder and management center 200. Therefore, the name of the created account may be the identity information of the electronic device 100, and the default password for login may be the confirmation code. In step S503, the recorder and management center 200 may send the confirmation code to the electronic device 100. The user may login to the created account with the identity information of the electronic device 100 as the account name and the confirmation code as the default password.

FIG. 3E illustrates the method for logging in to account and sending the recorded files to 3^{rd} party's address in the recorder and management center 200 after recording voices or videos according to one embodiment of the present invention, and the method of present invention may perform the following steps. In step S601, the recorder and management center 200 may receive the identity information of the electronic device 100, an account name, an account password and a login request form the computer 600. In step S602, the user logs in to the account. The recorder and management center 200 may send a list of recorded files to the computer 600. In step S603, the recorder and management center 200 may receive a sending request for at least a recorded file selected by the user and at least a destination address of 3^{rd} party's computer. In step S604, the recorder and management center 200 may generate a unique data path and a unique password corresponding to the recorded file. The unique data path and the unique password may further be expired once they have been used to prevent from abuse of the recorded files from people who have the data path and the password later. The number of times, the duration of visits, downloads through the unique data path may further be limited and configured by the user of the electronic device 100 after the user logs in the account. In step S605, the recorder and management center 200 may send the data path and the password to the destination address. In one embodiment, the recorder and management center 200 may generate more different data paths and corresponding different passwords according to the number of received destination addresses of 3^{rd} party's computers. More specifically, a user may input or select from default a plurality of destination addresses of 3^{rd} party's computers. The recorder and management center 200 may generate a unique data path and a unique password for each destination address and send unique data path and the unique password to each destination address respectively.

FIG. 3F illustrates the method for logging in to account and configuring the sending mechanism of the recorded files to 3^{rd} party's address after recording voices or videos according to one embodiment of the present invention, and the method of present invention may perform the following steps. In step S701, the recorder and management center 200 may receive the identity information of the electronic device 100, an account name, an account password and a login request form the computer 600. In step S702, the user login to the account. The recorder and management center 200 may send a list of recorded files to the computer 600. In step S703a, the recorder and management center 200 may receive a sending request for at least a recorded file selected by the user, at least a destination address of 3^{rd} party's computer and a pre-set condition, such as a specific date, a duration that the user has not logged into the account.

A person of ordinary skill in the art can understand the pre-set condition may not only be applied to a selected recorded file but also the newly recorded files. Thus, the user may also login to the account and set pre-set condition as a policy for newly recorded files, such as immediately sending the newly recorded files to specific destination addresses or sending to the destination address after a few days from the user's last login. In some embodiments of the present invention, the pre-set condition may comprise some conditions for newly recorded files or specific recorded files, wherein the recorder and management center 200 may be configured to send the aforementioned files immediately to specific destination address, to send the aforementioned as long as the user has not logged in for a pre-sent time duration, or even to send the aforementioned files once the battery power of the electronic device 100 drops to a specific level. In one embodiment of the present invention, the pre-set condition may also be “always true”, that is, the recorder and management center 200 may be configured to always share the aforementioned files. The sending mechanism may be configured by the steps of S701 to S703a.

In step S703b, the recorder and management center 200 may decide whether the pre-set condition has been met. Once the pre-set condition has been met, the recorder and management center 200 may prepare to send the recording files to the destination address in step S704 and S705. In step S704, the recorder and management center 200 may generate a unique data path and a unique password corresponding to the recorded file. The unique data path and the unique password may further be expired once they have been used to prevent from abuse of the recorded files from people who have the data path and the password later. In step S705, the recorder and management center 200 may send the data path and the password to the destination address. In one embodiment, the recorder and management center 200 may generate more different data paths and corresponding different passwords according to the number of received destination addresses of 3^{rd} party's computers. More specifically, a user may input or select from default a plurality of destination addresses of 3^{rd} party's computers. The recorder and management center 200 may generate a unique data path and a unique password for each destination address and send unique data path and the unique password to each destination address respectively.

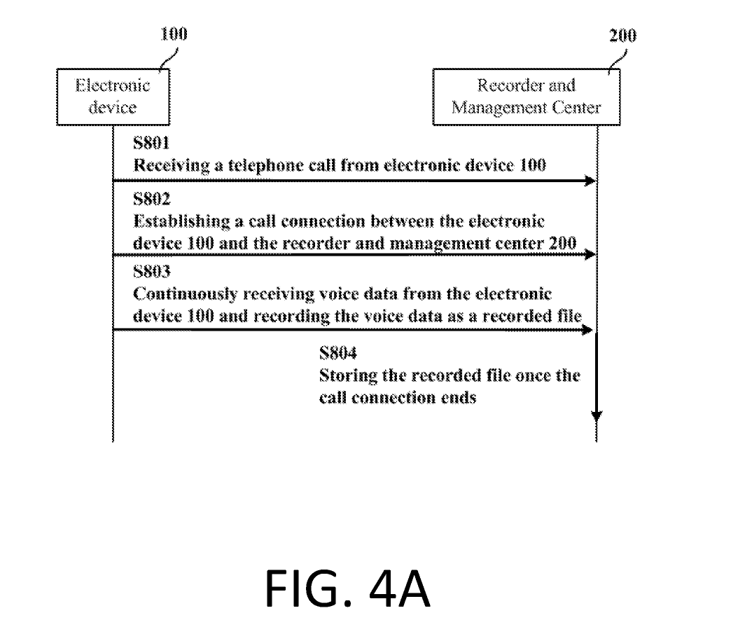

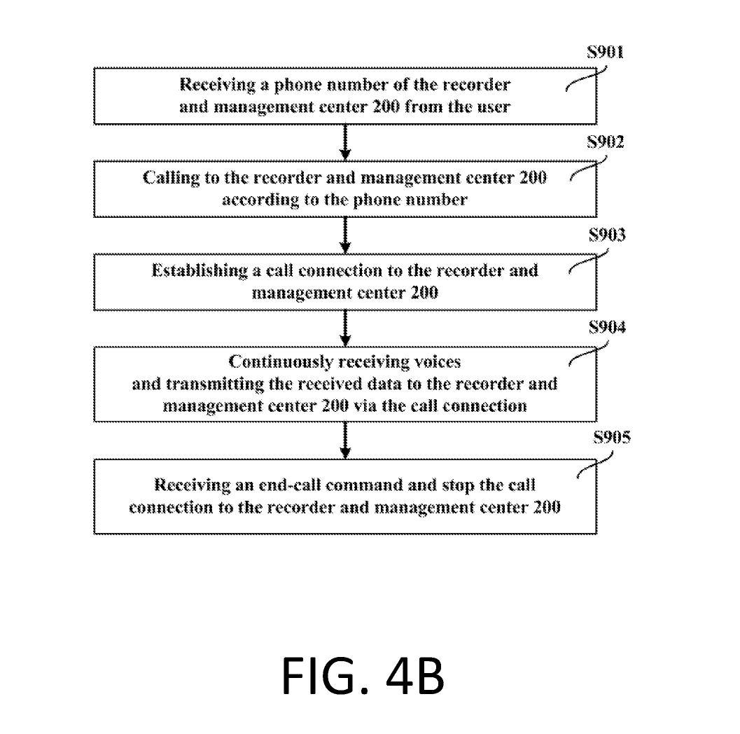

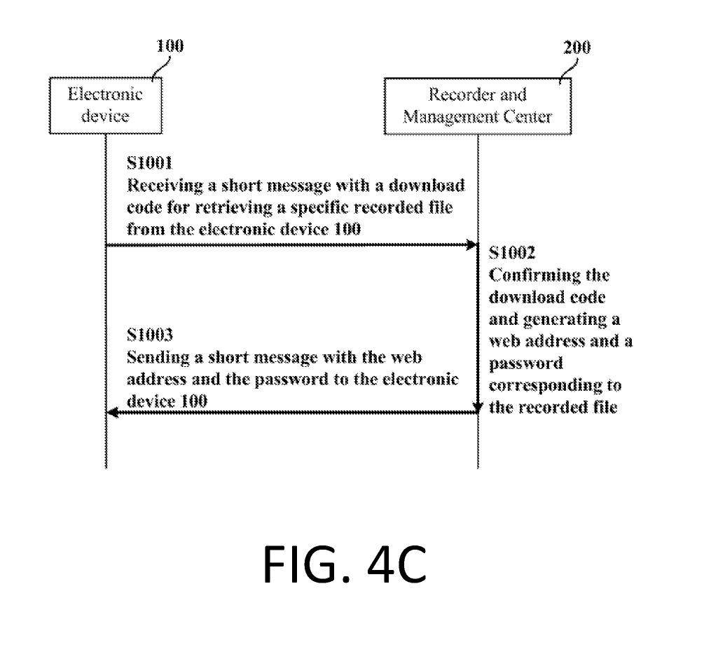

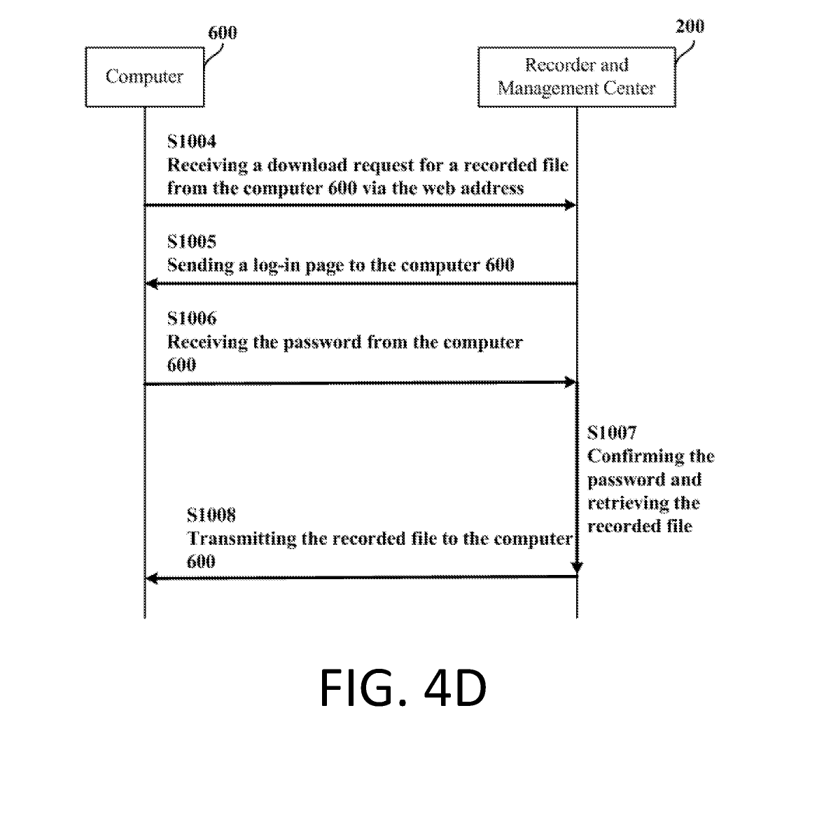

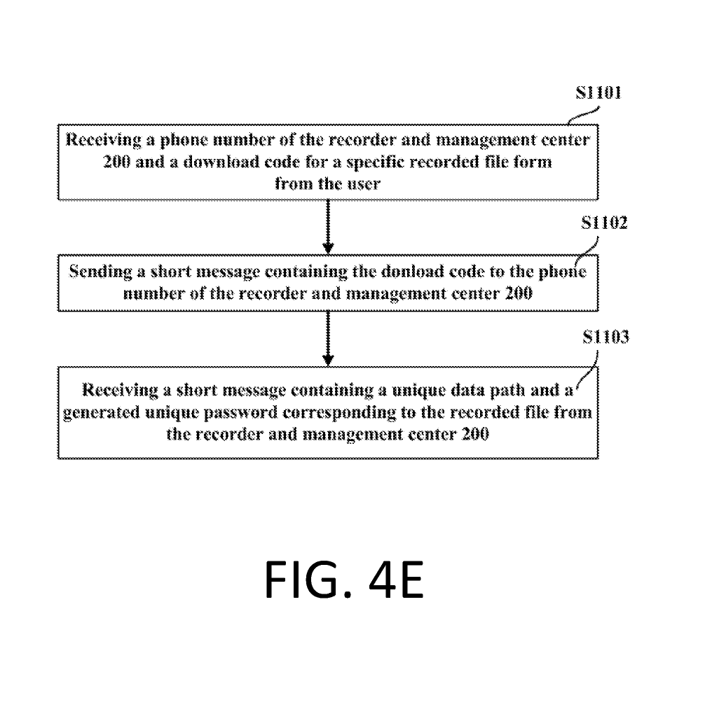

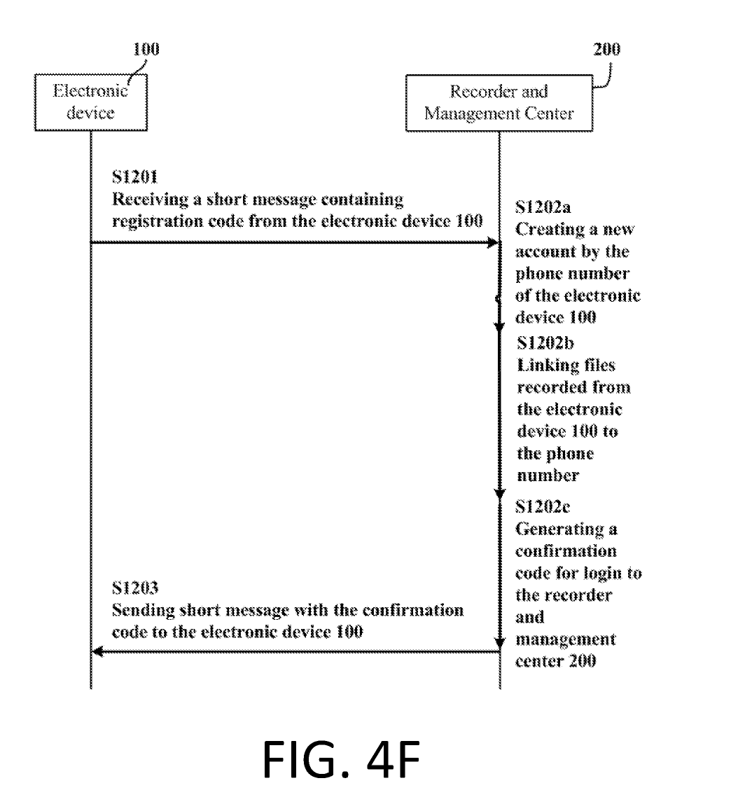

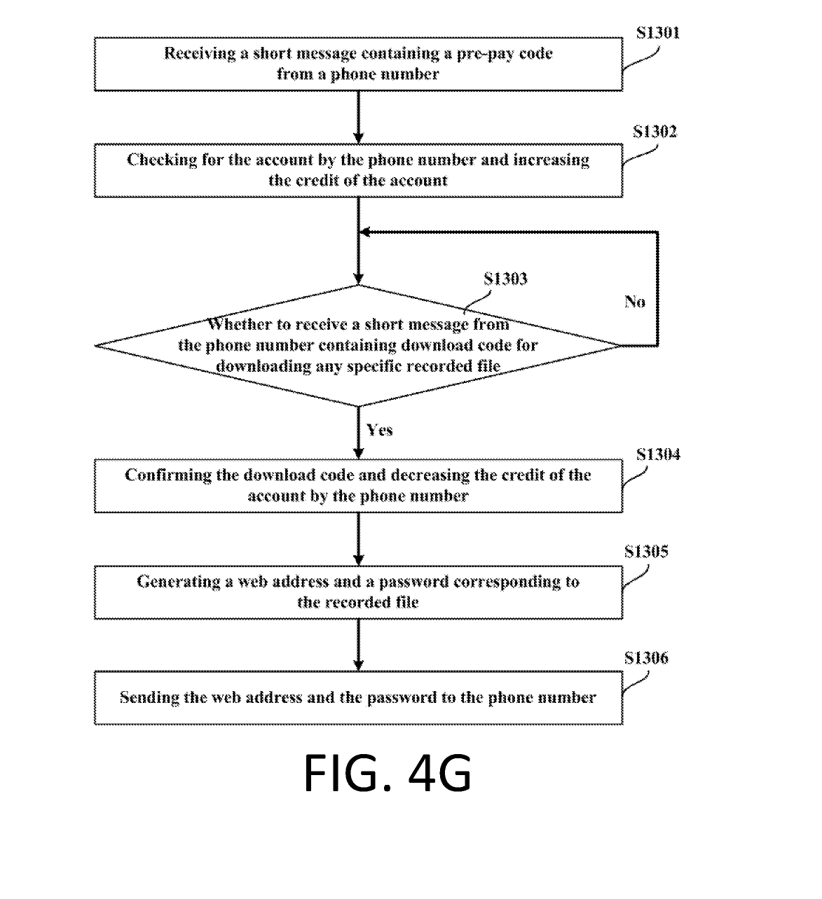

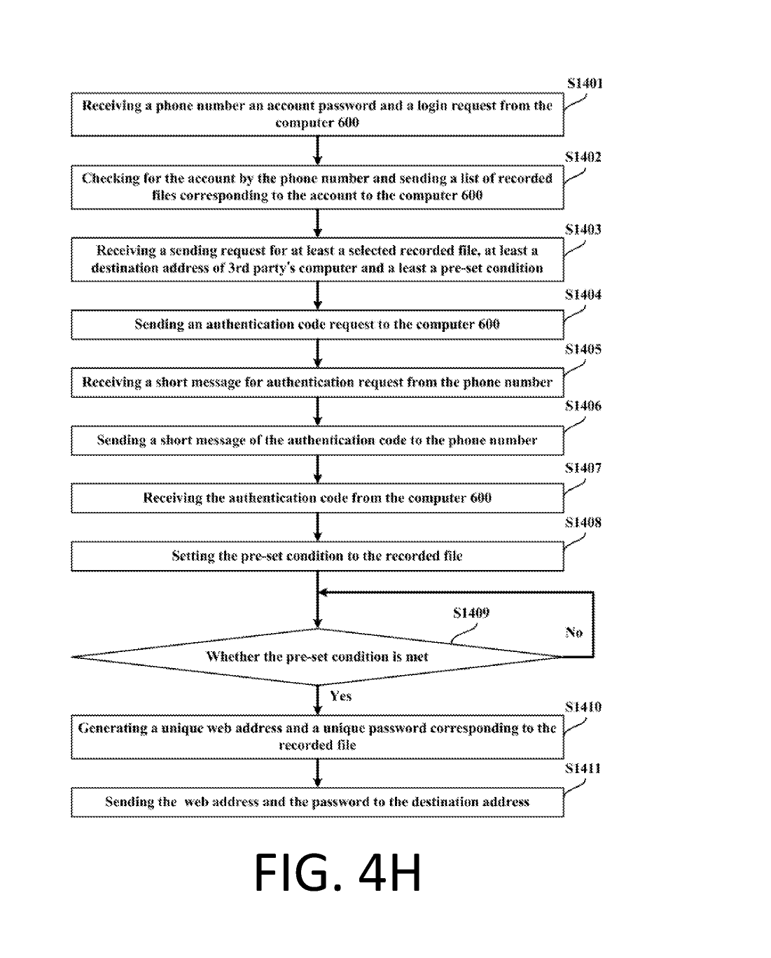

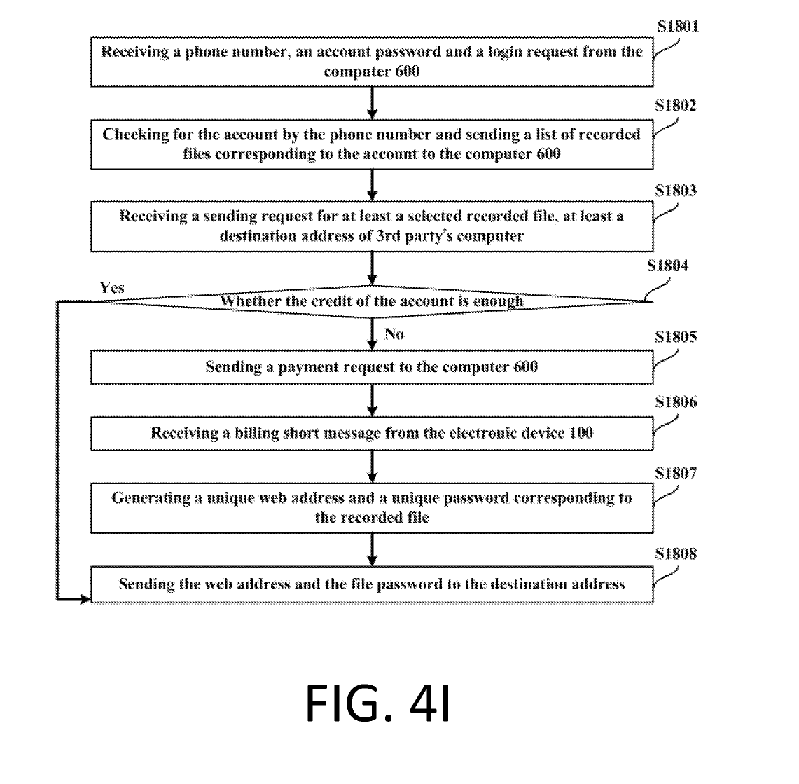

FIGS. 4A to 4I are flowcharts respectively illustrating the method for remotely recording voice or video data, downloading a recorded file from the recorder and management center 200, registering for an account of the recorder and management center 200, pre-paying for the credit of a registered account, configuring the sending mechanism of a recorded file, verifying the payment for sending recorded files and sending a recorded file to 3^{rd} party's address according to one embodiment of the present invention. The method of the present invention may be applied on the electronic device 100 or applied on the recorder and management center 200 of the present invention.

FIG. 4A illustrates the method for recording voice in the recorder and management center 200 through the electronic device 100 according to one embodiment of the present invention, and the method of present invention may perform the following steps. In step S801, the recorder and management center 200 receives a telephone call from the electronic device 100 having telephone function. In step S802, the recorder and management center 200 and the electronic device 100 may establish a call connection between each over the telecommunication network system 410. In step 803, the recorder and management center 200 may continuously receive voice data from the electronic device 100. The recorder and management center 200 may record the received data. In step 804, while the recorder and management center 200 disconnected from the electronic device 100, that is, the call connection ends, the recorder and management center 200 may stop recording and store the recorded data as a recorded file. The recorder and management center 200 may further compress the recorded data into an audio file format, such as an MP3, AAC, ATRAC, WMA file format. The recorder and management center 200 may further provide additional function for the recorded file as cloud services, such as backup the recorded file to an assigned public cloud and transformation of the recorded voice data into text through voice recognition. In some embodiments of the present invention, voice over IP services which utilize the IP network over the telecommunication network system 410 may be used instead of telephone calls in aforementioned method.

FIG. 4B illustrates the method for remotely recording voices or videos through the electronic device 100 and storing the recorded data in the recorder and management center 200 according to one embodiment of the present invention, and the method of present invention may perform the following steps. In step S901, the electronic device 100 may receive phone number of the recorder and management center 200 from the user. In step S902, the electronic device 100 may call the recorder and management center 200 according to the phone number. In step S903, the electronic device 100 may establish a call connection to the recorder and management center 200 over the telecommunication network system 410. In step S904, the electronic device 100 may continuously receive voices and transmit the received data to the recorder and management center 200 via the call connection. In step S905, when the user ends the call, the electronic device 100 may receive an end-call command and stop the call connection to recorder and management center 200.

FIG. 4C illustrates the method for downloading a recorded file from the recorder and management center 200 through the electronic device 100 according to one embodiment of the present invention, and the method of present invention may perform the following steps. In step S1001, the recorder and management center 200 may receive a short message with a code representing for a download request for a specific recorded file from the electronic device 100. The codes in the short messages may have a specific format for requesting the recorder and management center 200 for different services. For example, “995” may represent for downloading the last recorded file. “9951” may represent for downloading the file recorded previous to the last recorded file, and “9952” may represent for downloading the file recorded previous to the file corresponding the “9951”. In step S1002, the recorder and management center 200 may confirm the download code in the short message and generate a unique web address and a unique password corresponding to the recorded file. To prevent from abuse of the recorded files from people who have the web address and the password later, the unique web address may be expired once it has been visited, and the unique password may be invalid once it has been received through the web address. In step S1003, the recorder and management center 200 may send a short message with the web address and the password to the electronic device 100. The user of the electronic device may download the recorded file by visiting the web address and sending the password to the recorder and management center 200. In some embodiments of the present invention, instant messages which utilize the IP network over the telecommunication network system 410 may be used instead of short messages in aforementioned method.

FIG. 4D illustrates the method for downloading a recorded file from the recorder and management center 200 through the computer 600 after receiving a web address and a password corresponding to the recorded file according to one embodiment of the present invention, and the method of present invention may perform the following steps. In step S1004, the recorder and management center 200 may receive a download request for the recorded file mentioned in step S1003 from the computer 600 via the web address. In step S1005, the recorder and management center 200 may send a log-in page to the computer 600. In step S1006, the recorder and management center 200 may receive the password corresponding to the recorded file from the computer 600. The password may further be corresponding to the web address, that is, the password may not be applicable for a download request from another web address for even the same recorded file. In step S1007, the recorder and management center 200 may confirm the password and retrieve the recorded file for downloading to the computer 600. In step 1008, the recorder and management center 200 may transmit the recorded file to the computer 600. The recorded file may be transmitted to the computer 600 and saved as a file, or be transmitted as a streaming multimedia to be played on the computer 600.

FIG. 4E illustrates the method for downloading a recorded file through electronic device 100 from the recorder and management center 200 according to one embodiment of the present invention, and the method of present invention may perform the following steps. In step S1101, the electronic device 100 may receive a phone number of the recorder and management center 200 and a download code for a specific recorded file from the user. The codes in the short messages may have a specific format for requesting the recorder and management center 200 for different services. For example, “995” may represent for downloading the last recorded file. “9951” may represent for downloading the file recorded previous to the last recorded file, and “9952” may represent for downloading the file recorded previous to the file corresponding the “9951”. In step S1102, the electronic device 100 may send a short message containing the download code to the phone number of the recorder and management center 200. In some embodiments of the present invention, the phone number of the recorder and management center 200 for a phone call and the phone number of the recorder and management center 200 for a short message may be different. In step S1103, the electronic device 100 may receive a short message containing a unique web address and a unique password generated corresponding to the recorded file from the recorder and management center 200. The user of the electronic device 100 may download the recorded file by visiting the data path and sending the password to the recorder and management center 200. In some embodiments of the present invention, instant messages which utilize the IP network over the telecommunication network system 410 may be used instead of short messages in aforementioned method.

FIG. 4F illustrates the method for registering an account in the recorder and management center 200 after recording voices for downloading or managing the recorded files according to one embodiment of the present invention, and the method of present invention may perform the following steps. In step S1201, the recorder and management center 200 may receive a short message containing a code for registration request from the electronic device 100. The codes in the short messages may have a specific format for requesting the recorder and management center 200 for different services. For example, “995” may represent for downloading the last recorded file, and “995000” may represent for registration request for a new account in the recorder and management center 200. In step S1202a, the recorder and management center 200 may create a new account by the phone number of the electronic device 100. In step S502b, the recorder and management center 200 may link files recorded from the electronic device 100 to the account for providing the user the recorded files after the user logs in. In step S502c, the recorder and management center 200 may generate a confirmation code for login to the recorder and management center 200. Therefore, the name of the created account may be the phone number of the electronic device 100, and the default password for login may be the confirmation code. In step S503, the recorder and management center 200 may send the confirmation code to the electronic device 100. The user may login to the created account with the phone of the electronic device 100 as the account name and the confirmation code as the default password.

FIG. 4G illustrates the method for pre-paying for credits of an account and downloading the recorded file with the paid credits in the recorder and management center 200 after recording voices according to one embodiment of the present invention, and the method of present invention may perform the following steps. In step S1301, the recorder and management center 200 may receive a short message containing a code for pre-paying for credits of an account corresponding to the phone number of the device 100. The codes in the short messages may have a specific format for requesting the recorder and management center 200 for different services. For example, “995” may represent for downloading the last recorded file, and “995008” may represent for pre-paying credit of the account with a billing short message, for which the user may pay an SMS fee to the recorder and management center 200, in the recorder and management center 200. In step S1302, the recorder and management center 200 may check for the account by the phone number and increase the credit of the account. The payment for the increased credit of the account may be received from the received billing short message, for which the user may pay an SMS fee to the recorder and management center 200, in step S1301. Therefore, the user may pre-pay for the credits of the account in step S1301 and S1302.

The credits of the account may be consumed in exchange for cloud-based services for managing the recorded files or uploaded files, such as sharing or sending the files to an assigned address. For example, sending a recorded file immediately to an assigned address may cost 1 credit of the account, and sending a recorded file to an assigned address under a pre-set condition may cost 2 credits of the account. The account may be recharged by sending a billing short message to the recorder and management center 200 or other address assigned by the recorder and management center 200. The recorder and management center 200 may be connected to the business support system of the telecommunication network system 410 to fulfill the transaction of pre-payment by increasing the credit of the user account and charging additional fees in the user's telecommunication charges. Other payment mechanism for recharging the account (increasing the credits of the account) may be adopted such as payment by credit card, especially electronic payment mechanism.

In step S1303, the recorder and management center 200 may decide whether to receive a short message from the phone number containing download code for downloading any specific recorded file. In step S1304, upon receiving a short message from the phone number containing a download code, the recorder and management center 200 may confirm the download code and decrease the credit of the account by the phone number. In step S1305, the recorder and management center 200 may generate a unique web address and a unique password corresponding to the recorded file. In step S1306, the recorder and management center 200 may send a short message with the web address and the password to the electronic device 100. The user of the electronic device 100 may download the recorded file by visiting the web address and sending the password to the recorder and management center 200. In some embodiments of the present invention, instant messages which utilize the IP network over the telecommunication network system 410 may be used instead of short messages in aforementioned method.

FIG. 4H illustrates the method for configuring the sending mechanism of the recorded files, authenticating for the configuration and sending the recorded file to 3^{rd} party's address after recording voices according to one embodiment of the present invention, and the method of present invention may perform the following steps. In step S1401, the recorder and management center 200 may receive a phone number of the electronic device 100 as the name of the account, an account password and a login request form the computer 600. In step S1402, the recorder and management center 200 may check for the account by the phone number and send a list of recorded files to the computer 600. In step S1403, the recorder and management center 200 may receive a sending request for at least a recorded file selected by the user, at least a destination address of 3^{rd} party's computer and a pre-set condition (such as a specific date or a duration that the user has not logged into the account) to send the recorded file. In step S1404, the recorder and management center 200 may send an authentication code request to the computer 600. The authentication code request may remind the user to send a short message for authentication through the phone number. In step S1405, the recorder and management center 200 may receive a short message for authentication request from the phone number. In step S1406, the recorder and management center 200 may send a short message of the authentication code to the phone number. In step S1407, the recorder and management center 200 may receive the authentication code from the computer 600 after the user receives the authentication code in the electronic device 100. In step S1408, the recorder and management center 200 may set the pre-set condition to the recorded file. Thus, the configuration of the sending mechanism and the authentication of the configuration have been fulfilled through step S1401 to S1408.

In step S1409, the recorder and management center 200 may decide whether the pre-set condition is met. Once the pre-set condition has been met, the recorder and management center 200 may prepare to send the recording files to the destination address in step S1410 and S1411. In step S1410, the recorder and management center 200 may generate a unique web address and a unique password corresponding to the recorded file. The unique web address and the unique password may be expired once they have been used to prevent from abuse of the recorded files from people who have the data path and the password later. In step S1411, the recorder and management center 200 may send the web address and the password to the destination address. In one embodiment, the recorder and management center 200 may generate more different web addresses and corresponding different passwords according to the number of received destination addresses of 3^{rd} party's computers. More specifically, a user may input or select from default a plurality of destination addresses of 3^{rd} party's computers. The recorder and management center 200 may generate a unique web address and a unique password for each destination address and send unique web addresses and the unique password to each destination address respectively.

While the methods previously described may include a number of steps that may appear to occur in a specific order, it should be appreciated that these methods may contain more or fewer steps, that the order these steps may be exchanged, and that different steps may be combined. For example, the step S1404 to S1407 may be omitted, that is, the authentication code may not be generated and sent to the electronic device 100 and not be received from the computer 600.

FIG. 4I illustrates the method for verifying the payment (credit) of a user account and sending the recorded file to a user-assigned address after recording voices according to one embodiment of the present invention, and the method of present invention may perform the following steps. In step S1801, the recorder and management center 200 may receive a phone number of the electronic device 100 as the name of the account, an account password and a login request form the computer 600. In step S1802, the recorder and management center 200 may check for the account by the phone number and send a list of recorded files to the computer 600. In step S1803, the recorder and management center 200 may receive a sending request for at least a recorded file selected by the user, at least a destination address of 3^{rd} party's computer. In step S1804, the recorder and management center 200 may check the credit of the account. If the credit of the account is not enough, in step S1805, the recorder and management center 200 may send a payment request to the computer 600 to remind the user for the payment to the service of sending the recorded file. In step S1806, the recorder and management center 200 may receive a billing short message for the service of sending the recorded file, that is, the user may pay an additional fee for the service of sending the recorded file in the user's telecommunication charges by sending the billing short message. The recorder and management center 200 may send the recorded file by performing steps S1807 and S1808 upon receiving the billing short message, that is, the recorder and management center 200 may generate a unique web address and a unique password corresponding to the recorded file and send the web address and the password to the destination address of 3^{rd} party's computer.

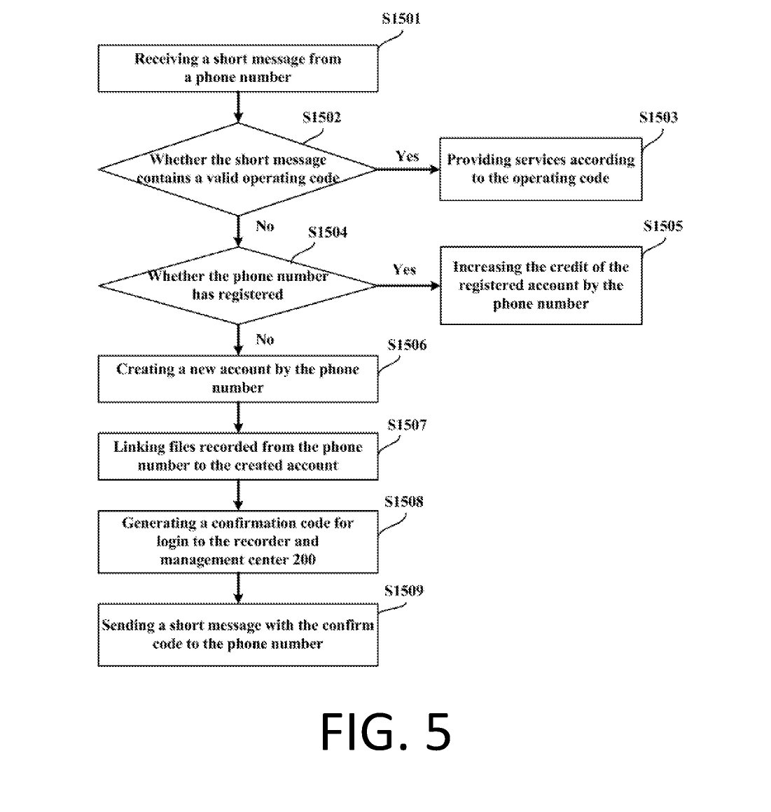

FIG. 5 is a flowchart illustrating the method for receiving a billing short message containing an operating code and providing services corresponding to the operating code according to one embodiment of the present invention. The method of the present invention may be applied on the recorder and management center 200 of the present invention and the method of present invention may perform the following steps. In step S1501, the recorder and management center 200 may receive a short message from a phone number. In step S1502, the recorder and management center 200 may check whether the short message contains a valid operating code. If the short message contains a valid operating code, the recorder and management center 200 in step S1503 may provide services according to the operating code. The operating codes in the short messages may have a specific format for requesting the recorder and management center 200 for different services. For example, “995” may represent for downloading the last recorded file, and “995000” may represent for registration request for a new account in the recorder and management center 200.

If the short message does not contain a valid operating code, the recorder and management center 200 in step S1504 may check whether the phone number has registered. If the phone number has registered, in step S1505, the recorder and management center 200 may increase the credit of the registered account by the phone number with the billing short message, for which the user may pay an SMS fee to the recorder and management center 200. If the phone number has not registered, in step S1506, the recorder and management center 200 may create a new account by the phone number. In step S1507, the recorder and management center 200 may link files recorded from the electronic device 100 to the account for providing the user the recorded files after the user logs in. In step S1508, the recorder and management center 200 may generate a confirmation code for login to the recorder and management center 200. Therefore, the name of the created account may be the phone number of the electronic device 100, and the default password for login may be the confirmation code. In step S1509, the recorder and management center 200 may send the confirmation code to the electronic device 100. The user may login to the created account with the phone of the electronic device 100 as the account name and the confirmation code as the default password. Therefore, the recorder and management center 200 may provide services according to an operating code in a billing short message, for which the user of the phone number may pay an SMS fee to the recorder and management center 200.

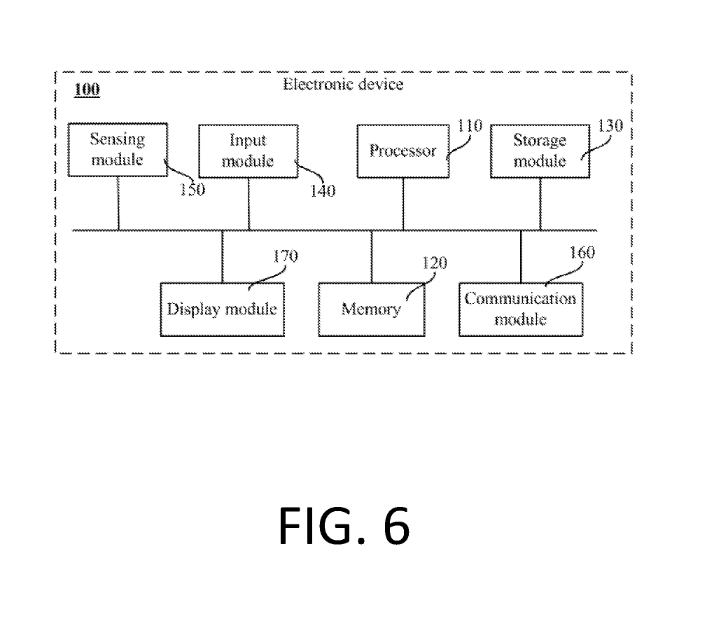

FIG. 6 is a block diagram illustrating the electronic device 100 according to one embodiment of the present invention. Referring to FIG. 6, the electronic device 100 may comprise a processor 110 for controlling the electronic device 100, a memory 120 for temporarily storing sensed data for processing, a storage module 130 for buffering the sensed data for uploading or remote recording while the electronic device 100 disconnected with the network system 400, an input module 140 for receiving users' input for remote recording and download the recorded files, a sensing module for sensing from the environment to generate sensed data, a communication module 160 for transmitting the sensed data for remote recording and receiving an URL for downloading the recorded file, and a display module 150 for displaying the received URL for downloading the recorded file. The input module 140 may receive a recording command from the user of the electronic device 100. The sensing module 150 then may be activated to generate sensed data which may be temporarily stored in the memory 120. The communication module 160 may transmit the sensed data to the recorder and management center 200 for remote recording. Specifically, the communication module 160 may establish a connection to the recorder and management center 200 and start continuously transmitting the sensed data as a data stream to the recorder and management center 200. In one embodiment of the present invention, the communication module 160 may check the connection to the recorder and management center 200, and while the communication module 160 not connected to the recorder and management center 200, the electronic device 100 may store the sensed data in the storage module 130 for buffering. Once the connection between the electronic device 100 and the recorder and management center 200 has been established, the communication module 150 may upload the sensed data in buffer. The input module 140 may receive a disconnect command from the user. Then, the sensing module 150 may stop sensing from the environment, and the communication module 160 may disconnect with the recorder and management center 200. The recorder and management center 200 may stop recording and save the recorded data as a recorded file. The input module 140 may receive a download command from the user when the user needs to share the recorded file. A download request may be generated. The communication module 160 may transmit the download request to the recorder and management center 200 and receive a message containing an URL of the recorded file and a password for retrieving the recorded file from the recorder and management center 200. The display module 160 may display the message to the user. The user may input a sharing command and an assigned address (such as e-mail address or phone number) via the input module 140, and the communication module 160 may transmit the message to the assigned address.

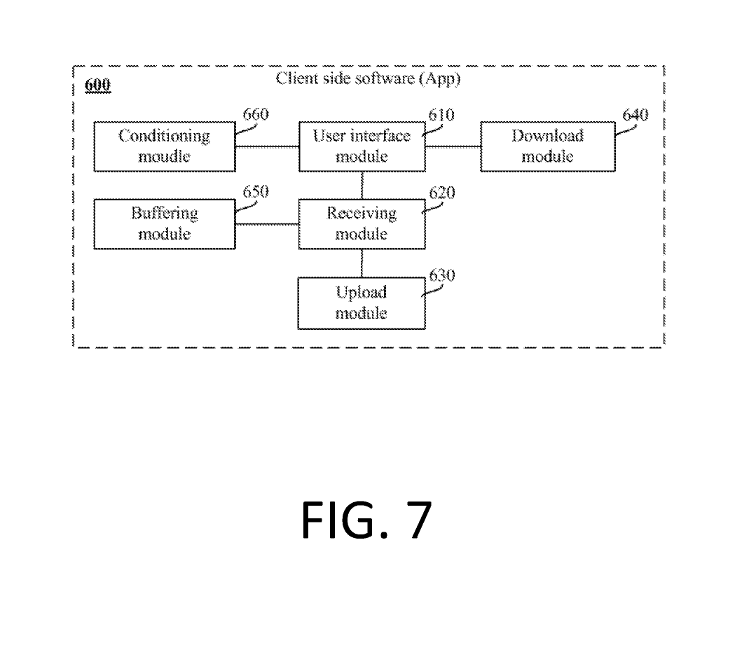

FIG. 7 is a block diagram illustrating a client side software 600 installed in the electronic device 100 according to one embodiment of the present invention. Referring to FIG. 7, the client side software 600 may comprise a user interface module 610 for receiving users' input for remote recording and download the recorded files, a receiving module 620 for receiving sensed data, an upload module 630 for uploading the sensed data to the recorder and management center 200 for remote recording and a download module 640 for receiving an URL for downloading the recorded file. The client side software 600 may further include a buffering module 650 for buffering the sensed data for uploading or remote recording before connecting to the recorder and management center 200. In addition, the client side software 600 may further include a conditioning module 660 for setting conditions to activate the remote recording functions such as a specific time, a gesture/motion input . . . etc. The input module 140 may provide a user interface for receiving a recording command from the user of the client side software 600. The receiving module may be activated to receive sensed data according to the recording command. The upload module 630 may upload sensed data to the recorder and management center 200 for remote recording. Specifically, the upload module 630 may establish a session to the recorder and management center 200 and upload streaming data to the recorder and management center 200. In one embodiment of the present invention, the upload module 630 may check the connection to the recorder and management center 200, and while not connected to the recorder and management center 200, the buffering module 650 may temporarily store the sensed data. Once the connection to the recorder and management center 200 has been established, the upload module 630 may upload the sensed data in the buffering module 650. The user interface module 610 may provide a user interface for receiving a disconnect command from the user. Then, the receiving module 620 may stop receiving sensed data, and the upload module 630 may disconnect with the recorder and management center 200. The recorder and management center 200 may stop recording and save the recorded data as a recorded file. In addition, the user interface module 610 may further provide a user interface for receiving a download command from the user when the user needs to share the recorded file. The download module 640 may send a download request to the recorder and management center 200 and receive a message containing an URL of the recorded file and a password for retrieving the recorded file from the recorder and management center 200. Furthermore, the user input module 610 may provide a user interface for receiving a sharing command and an assigned address (such as e-mail address or phone number), and the download module 640 may send the message to the assigned address.

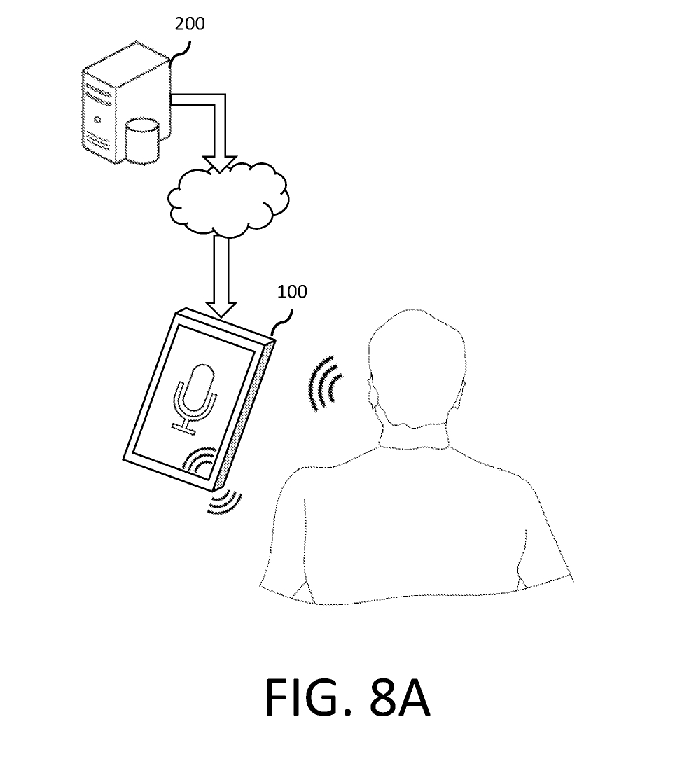

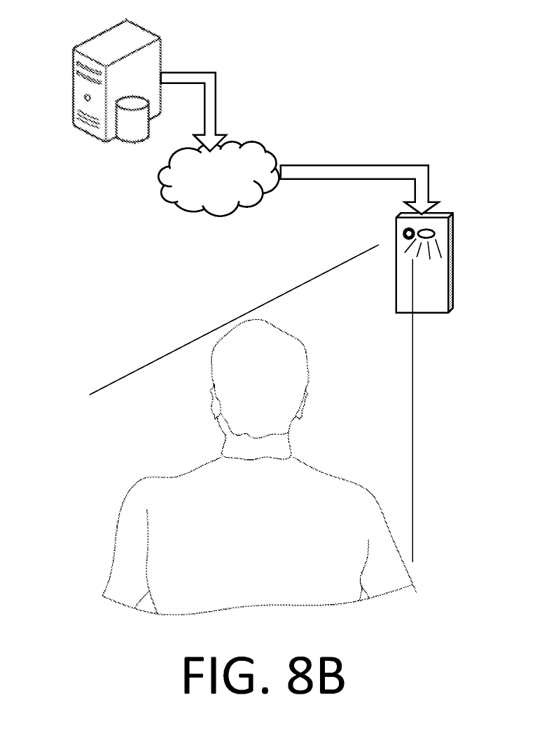

Referring to FIG. 8A, the electronic device 100 may include a microphone for collecting voice and a communication module for transmitting collected voice data to the recorder and management center 200 for recording. The electronic device 100 may request authentication such as a timestamp for proving the recording time from the recorder and management center 200. The recorder and management center 200 may obtain an authentication code including a timestamp. In some implementations, the recorder and management center 200 may obtain the authentication from a reliable 3^{rd} party. In some implementations, the recorder and management center 200 may obtain evidence and generate the authentication code based on the evidence. The evidence may comprise a requesting time and/or identification such as the IP address of the electronic device 100. The generation may comprise encoding based on at least a specific heuristic or algorithm, such as Morse code. In some implementations, the transformation may further include encryption such as public-key cryptography.

The authentication code may correspond to a sequence of audio outputs for the microphone of the electronic device 100 to collect the audio outputs while collecting voices from the environment. The sequence of the audio outputs may comprise sounds sequentially distributed in different volumes, frequencies, tones (waveforms) and/or durations. The electronic device 100 may further include a speaker to generate the sequence of the audio outputs according to the authentication code. In some implementations, for not interfering voice collected from the environment, the speaker may generate the sequence of the audio outputs in a frequency range below the range of audibility. The collected voice data may therefore include the audio outputs and be transmitted to the recorder and management center 200 to be recorded and stored as a recorded file. In some implementations, the recorder and management center 200 may further match the authentication code to the recorded file.

In some implementations, the recorder and management center 200 may extract the audio outputs from the recorded voice data and generate the authentication code based on the audio outputs. The extraction may be real-time while recording the voices or conducted to the recorded file after recording the voices. In some implementations, the recorder and management center 200 may further generate metadata of the recorded file based on the authentication code. The metadata may include a timestamp corresponding to time of requesting authentication. The metadata may be downloaded along with the recorded file.

In another embodiment of the present disclosure, referring to FIG. 8B, the electronic device 100 may include a camera for collecting images (or video) and a communication module for transmitting collected image (or video) data to the recorder and management center 200 for recording. The electronic device 100 may also request authentication from the recorder and management center 200. The recorder and management center 200 may obtain an authentication code. In some implementation, the authentication code may include a timestamp for providing a verifiable recording time.

In some implementations, the authentication code may correspond to a sequence of optical outputs for the camera of the electronic device 100 to collect the optical outputs while collecting images (or video) from the environment. The sequence of the optical outputs may comprise flashes of lights sequentially distributed in different brightness, colors, zones of illumination and/or durations. In some implementations, the electronic device 100 may further include an electronic flash unit to generate the sequence of the optical outputs. The electronic device 100 may generate the optical outputs according to the authentication code. The collected image (or video) data may therefore include the optical outputs and be transmitted to the recorder and management center 200 to be recorded and stored as a recorded file. In some implementations, the recorder and management center 200 may extract the optical outputs and generate the timestamp as the metadata of the recorded file.

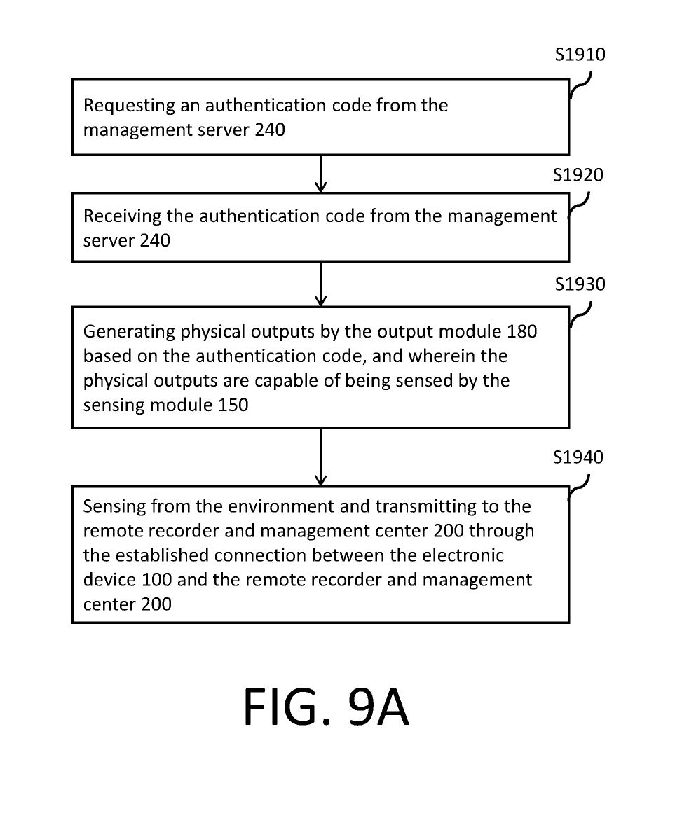

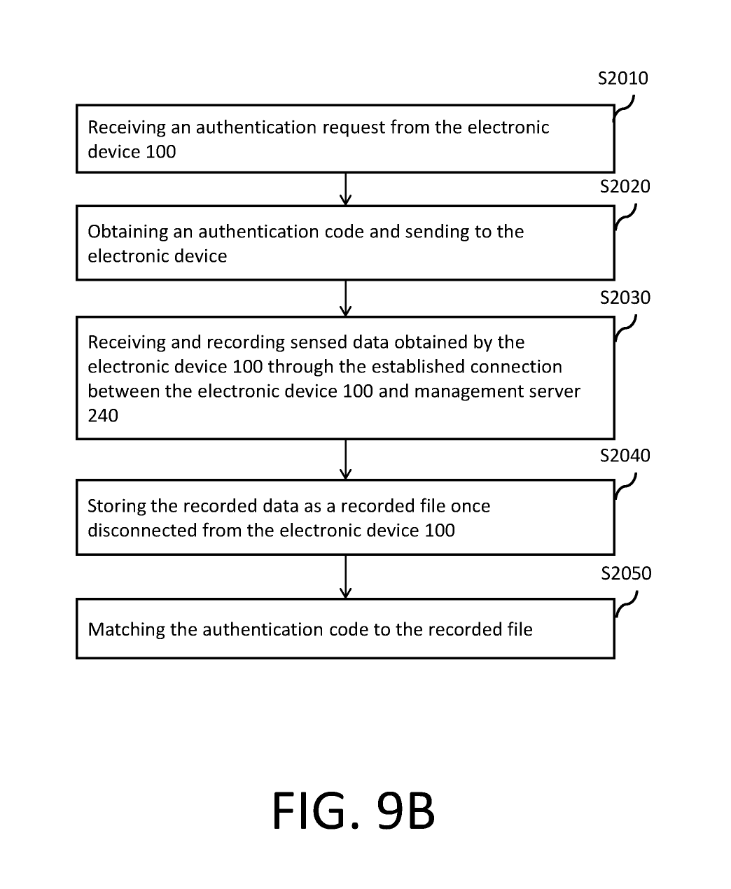

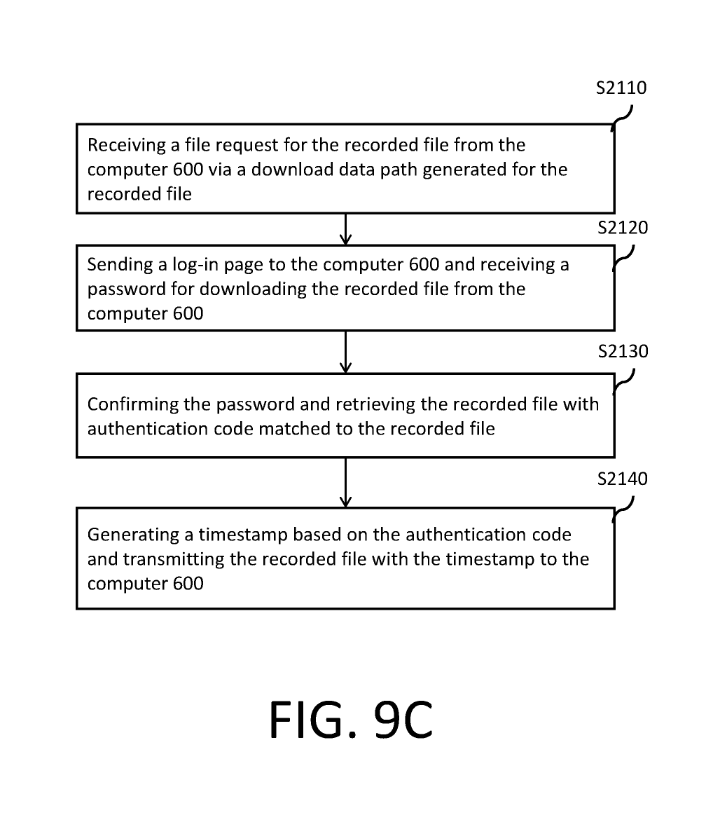

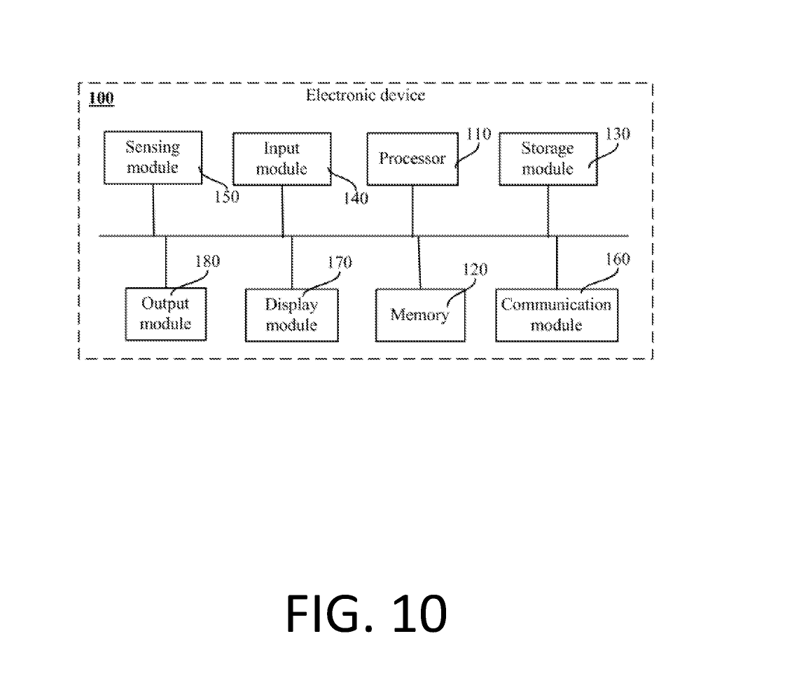

Referring to FIG. 9A, before the electronic device 100 continuously receiving sensed data and sending the received data to the management server 240 in step S204, the electronic device 100 may request an authentication code from the remote recorder 200 in step S1910. The management server 240 may obtain an authentication code. In some implementations, a timestamp may be included in the authentication code for providing a verifiable time reference to the evidence. The authentication code may correspond to at least one pattern of a sequence of physical outputs. The pattern may include one or more parameters correspond to the sequence of physical outputs such as type, number, a start time and an end time of the physical outputs. The pattern may further include parameters correspond to each of the physical outputs such as type, strength, duration or one or more other characteristics of each physical output. The management server 240 may send the authentication code to the electronic device 100. In step S1920, the electronic device 100 may receive the authentication code from the management server 240. In step S1930, the electronic device 100 may generate physical outputs in the pattern according to the authentication code. The electronic device 100 may comprise an output module 180 (depicted in FIG. 10) for generating the physical outputs. The output module 180 may be paired with the sensing module 150. That is, the physical outputs may be sensed by the sensing module 150. For example, the output module 180 may generate optical and/or audio outputs, and the sensing module 150 may be include a camera and/or microphone for receiving the optical and/or audio outputs.

In step S1940 (also similarly depicted as step S204 in FIG. 2B), the electronic device 100 may continuously sense from the environment and generate sensed data by the sensing module 150. The sensed data may include the physical outputs generated based on the authentication code. The electronic device 100 may transmit the sensed data to the management server 240 through the connection established in step S203 (depicted in FIG. 2B) for recording the sensed data as a recorded file.

Referring to FIG. 9B, in step S2010, the recorder and management center 200 may receive an authentication request from the electronic device. In step S2020, the recorder and management center 200 may obtain an authentication code according to the request. In some implementations, a timestamp may be included in the authentication code for providing a verifiable time reference to the evidence. In step S2030, the recorder and management center 200 may further send the authentication code to the electronic device 100. The authentication code may correspond to at least one pattern of a sequence of physical outputs for the electronic device 100 to generate. The authentication code may correspond to at least one pattern of a sequence of physical outputs such as, for example, the type, strength, duration or one or more other characteristics of each physical output. After the electronic device 100 sensing and transmitting sensed data from the environment, in step S2030, the recorder and management center 200 may receive and record the sensed data through the connection established in step S204 depicted in FIG. 2B. In step S2040, the recorder and management center 200 may store the recorded data as a recorded file once the recorder and management center 200 disconnected from the electronic device 100. In step S2050, the recorder and management center 200 may match the authentication code to the recorded file. In some implementations, the recorder and management center 200 may generate information based on the authentication code such as a timestamp and store as metadata of the recorded file. In some implementations, in step S2030, the recorder and management center 200 may directly identify the physical outputs while recording the sensed data and obtain the authentication code. The recorder and management center 200 may further store the recorded data as the recorded file and the authentication code as the metadata of the recoded file.

FIG. 9C is a flowchart of downloading process of recorded file with a timestamp performed by the recorder and management center 200 of the present disclosure. After the recorder and management center 200 sending the data path and password corresponding to the recorded file to the electronic device 100. In step S2110, the recorder and management center 200 may receive a file request for the recorded file from a computer 600 via a download data path generated for the recorded file. In step S2120, the recorder and management center 200 may send a log-in page to the computer 600. The recorder and management center 200 may receive the password for downloading the recorded file from the computer 600. In step S2130, the recorder and management center 200 may confirm the password and retrieve the recorded file with the authentication code matched to the file. In step S2140, the recorder and management center 200 may generate a timestamp based on the authentication code and transmitting the recorded file with the timestamp to the computer 600. In some implementations, instead of generating and transmitting the timestamp, the recorder and management center 200 may determine whether the timestamp is included in the authentication code and send the result with the recorded file to the computer 600. In some implementations, the recorder and management center 200 may evaluate a recording time from the timestamp and the recording time log. If there is an obvious difference between the recording time from the timestamp and the recording time from the time log, the recorder and management center 200 may send a message of the difference to the computer 600.

Referring to FIG. 10, the electronic device 100 may include at least one processor 110, a memory 120, a storage module 130, an input module 140, a sensing module 150, a communication module 160, a display module 170 and an output module 180. The input module 140 may receive a receiving command and an authentication command from a user. The communication module 160 may establish a connection with the recorder and management center 200 for transmitting data to the recorder and management center 200 for recording. The sensing module 150 may sense at least one physical characteristic from the environment, and the output module 180 may generate physical outputs having the aforementioned physical characteristic. The processor 110 may connect the memory 120 storing instructions for the processor controlling the input module 140, the sensing module 150, the communication module 160 and the output module 180 to perform the aforementioned actions accordingly.

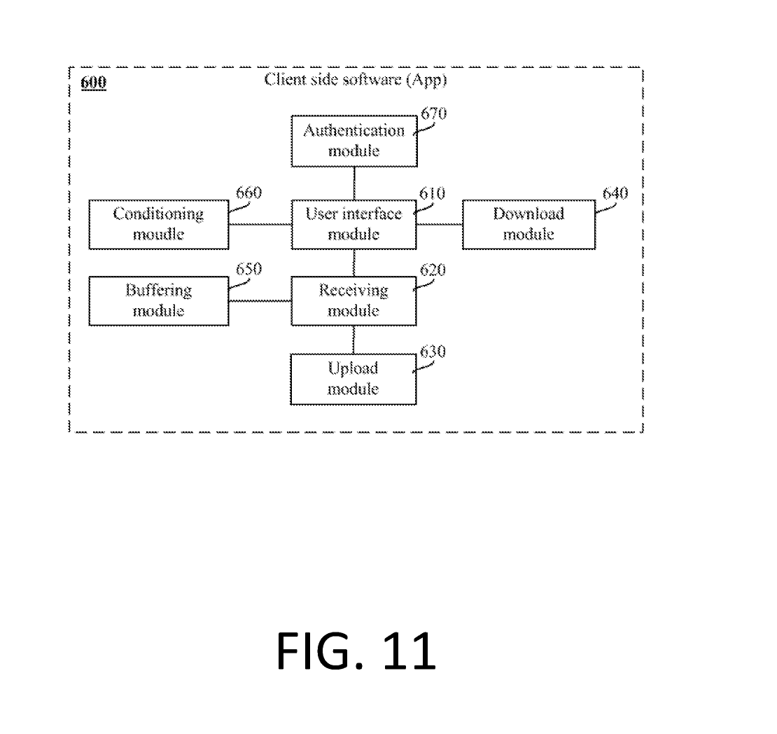

Referring to FIG. 11, the client side software 600 may include a user interface module 610, a receiving module 620, an upload module 630, a download module 640, a buffering module 650, a conditioning module 660 and an authentication module 670. The user interface module 610 may receive the receiving command and the authentication command from the interface module 140 of the electronic device 100. The authentication module 670 may receive the authentication code from the recorder and management center 200 for the output module 180 of the electronic device 100 to generate physical outputs based on the authentication code. The receiving module 620 may continuously receive sensed data including the physical outputs from the environment. The upload module 630 may upload the sensed data to the recorder and management center 200 for recording. The download module 640 may receive an URL for downloading the recorded file. In some implementation, a timestamp generated from the authentication code for providing a verifiable recording time may be downloaded along with the recorded file. In some implementations, the buffering module 650 may buffer the sensed data for uploading or remote recording before connecting to the recorder and management center 200. The conditioning module may allow a user to set conditions for activating the remote recording functions and/or authentication functions such as a specific time, a gesture/motion input . . . etc.

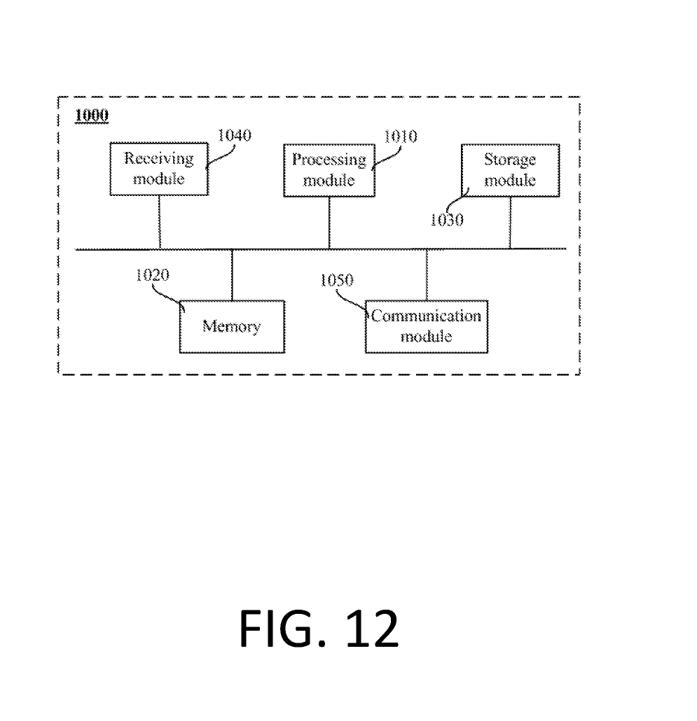

Referring to FIG. 12, the recorder and management device 1000 may include a processing module 1010, a memory 1020, a storage module 1030, a receiving module 1040 and a communication module 1050. The processing module 1010 may connect to the memory 1020, the storage module 1030, the receiving module 1040 and the communication module 1050 for performing instructions to control the recorder and management device 1000. The communication module 1050 may receive a recording command from the electronic device 100 and establish a connection with the electronic device 100 for receiving sensed data from the electronic device 100. The memory 1020 may temporarily store the sensed data as buffer. After the communication module 1050 disconnected from the electronic device 100, the processing module may store the sensed module in a file format as a recorded file in the storage module 1030. In some implementations, the processing module 1010 may further transmit recorded files from the storage module 1030 to a backup storage through the communication module 1050. In some implementations, the processing module 1010 may send a notification to the electronic device such as a short message, an e-mail or an instant message.

In one embodiment of the present disclosure, the recording command or the sensed data may come from a call center. The receiving module may receive the receiving commands and the sensed data from the call center. The processing module 1010 may further make the receiving module receive a disconnect command from the call center and stop receiving the sensed data. The processing module may further store the sensed data in a file format as the recorded file in the storage module 1030. In some implementations, under the control of the processing module 1010, the receiving module 1040 may further receive identification from the call center such as a telephone number calling into the call center. The processing module 1010 may further validate the identification to determine whether to receive sensed data from the call center. The storage module 1030 may further store the identification. While the communication module 1050 receiving an log-in command the identification from the electronic device 100 or the computer 600, the processing module 1010 may generate a page including recorded files corresponding to the identification for the communication module 1050 sending back to the electronic device 100 or the computer 600. The user may select at least one specific recorded file in the page for downloading. The communication module 1050 may further receive a download request for the selected file from the electronic device 100 or the computer 600. The processing module 1010 may generate an URL and a password for download. The communication module 1050 may send the URL and the password to the electronic device 100 or the computer 600. The processing module 1010 may further receive a download request through the URL. The processing module 1010 may receive and validate the password through the communication module 1050. According to the validation result, the processing module 1010 may retrieve the selected file from the storage module and send back to the visitor of the URL.

In one embodiment of the present disclosure, the processing module 1010 may receive a sharing command of a recorded file and a destination address from the electronic device 100 or the computer 600. The processing module 1010 may generate an URL and a password corresponding to the download request. The communication module 1050 may send the URL and the password to the destination address. The processing module 1010 may further receive a download request through the URL. The processing module 1010 may receive and validate the password through the communication module 1050. According to the validation result, the processing module 1010 may retrieve the selected file from the storage module and send back to the visitor of the URL.

In one embodiment of the present disclosure, the processing module 1010 may receive an authentication command through the communication module 1050 from the electronic device 100. The processing module 1010 may obtain an authentication code. The communication module 1050 may send the authentication code to the electronic device 100 for the electronic device 100 to generate physical outputs accordingly and sense including the physical outputs from the environment. The communication module 1050 may receive sensed data to be stored as a recorded file through the established connection from the electronic device 100. The processing module 1010 may match authentication code to the recorded file. In some implementations, for providing a verifiable recording time, a timestamp may be included in the authentication code. The processing module 1010 may further provide the timestamp and/or the recording time along with the recorded file for downloading. In some implementations, the processing module 1010 may generate metadata including the timestamp and/or the recording time of the recorded file based on the authentication code.

Previous descriptions are only embodiments of the present invention and are not intended to limit the scope of the present invention. Many variations and modifications according to the claims and specification of the disclosure are still within the scope of the claimed invention. In addition, each of the embodiments and claims does not have to achieve all the advantages or characteristics disclosed. Moreover, the abstract and the title only serve to facilitate searching patent documents and are not intended in any way to limit the scope of the claimed invention.

What is claimed is:

1. A method for remotely recording data sensed by an electronic device from environment, comprising:
receiving a recording request from the electronic device;
obtaining an authentication code and sending to the electronic device for the electronic device generating physical outputs based on the authentication code toward the environment and to be sensed by the electronic device;
connecting to the electronic device and receiving the sensed data including the physical outputs from the electronic device; and
recording the sensed data and storing the recorded data as a recorded file once disconnected from the electronic device.

2. The method according to claim 1, further comprising matching the authentication code to the recorded file for providing the authentication code alone with recorded file.

3. The method according to claim 1, further comprising:
receiving a download request of the recorded file from the electronic device;
generating a download address for downloading the recorded file; and
sending the download address to the electronic device.

4. The method according to claim 1, further comprising:
determining whether a pre-set condition for sharing the recorded file is met;
generating a download address for downloading the recorded file if the pre-set condition is met; and
sending the download address to an assigned address.

5. The method according to claim 1, wherein:
the recording request is a phone call with at least voice data as the sensed data;
the physical outputs include sounds; and
the receiving and recording of the sensed data starts upon call connected.

6. The method according to claim 1, wherein the physical outputs include optical outputs and the sensed data include video data.

7. The method according to claim 1, wherein the authentication code defines at least one of the number, strength, frequency, start time, end time and duration of the physical outputs.

8. The method according to claim 1, wherein the authentication code includes a timestamp.

9. The method according to claim 1, further comprising forwarding the sensed data to another electronic device for utilization of the sensed data during the recording of the sensed data.

10. A method for remotely recording data into a server by an electronic device, comprising:
receiving a recording command;
sending a recording request to the server and connecting to the server;
obtaining an authentication code from the server;
receiving data sensed from the environment and sending the data to the sever;
generating physical outputs based on the authentication code toward the environment and to be sensed by the electronic device during the receiving of data sensed from the environment;
receiving a disconnecting command and disconnecting with the server; and
wherein the data will be recorded as a recorded file in the server after the electronic device being disconnected with the server.

11. The method according to claim 10, further comprising:
detecting connectivity to the server;
buffering the sensed data while the electronic device being disconnected with the server; and
uploading the buffered data upon connecting to the server.

12. The method according to claim 10, further comprising:
receiving a download command;
sending a download request to the server;
receiving a download address generated corresponding to the recorded file from the server; and
displaying the download address.

13. The method according to claim 10, further comprising:
determining whether a pre-set condition for sharing the recorded file to an assigned address is met;
sending a sharing request to the server if the pre-set condition is met; and
wherein a download address corresponding to the recorded file will be sent to the assigned address by the server according to the sharing request.

14. The method according to claim 10, wherein the physical outputs include sounds and the data sensed from the environment include audio data.

15. The method according to claim 10, wherein the physical outputs include optical outputs and the sensed data include video data.

16. The method according to claim 10, wherein the authentication code defines at least one of the number, strength, frequency, start time, end time and duration of the physical outputs.

17. The method according to claim 10, wherein the authentication code includes a timestamp.

18. A system for remotely recording data sensed by an electronic device from the environment, comprising:
a receiving server for receiving a recording request from the electronic device and establishing a connection to the electronic device;
an authentication server for obtaining an authentication code and sending to the electronic device for the electronic device generating physical outputs based on the authentication code toward the environment and to be sensed by the electronic device;
a recorder server for receiving the sensed data including the physical outputs via the connection and recording the sensed data as a recorded file after being disconnected with the electronic device; and
a storage server for storing the recorded file.

19. The system according to claim 18, wherein the receiving server is a call center for receiving a phone call as the recording request and voices during the phone call as the sensed data, and the physical outputs include sounds.

20. The system according to claim 18, wherein the physical outputs include optical outputs and the sensed data include video data.

21. The system according to claim 18, wherein the authentication code defines at least one of the number, strength, frequency, start time, end time and duration of the physical outputs.

22. The system according to claim 18, wherein the authentication code includes a timestamp.

23. The system according to claim 18, wherein the receiving server further forwards the sensed data to another electronic device for utilization of the sensed data during the recording of the sensed data.

24. The system according to claim 18, further comprising:
a management server for receiving a download request for the recorded file from the electronic device, requesting a download address for the recorded file from the storage server and sending the download address to the electronic device;
a download server retrieving the recorded file and transmitting the recorded file to a computer which requests the recorded file by visiting the download address.

25. The system according to claim 18, further comprising:
a management server for receiving a sharing request for sending the recorded file to an assigned address, requesting a download address for the recorded file from the storage server and sending the download address to the assigned address;
a download server retrieving the recorded file and transmitting the recorded file to a computer which requests the recorded file by visiting the download address.

26. The system according to claim 25, wherein the sharing request comprise a pre-set condition, and the management server will send the download address to the assigned address if the pre-set condition is met.

27. An electronic device for remotely recording data into a server, comprising:
a processor;
a memory;
a storage module;
an input module for receiving a recording command from the user;
a sensing module for generating data sensed from the environment;
an output module for generating physical outputs capable of being sensed by the sensing module; and
a communication module for transmitting the data to the server when the sensing module is generating the data; and
a program, wherein the program is stored in the memory and configured to be executed by the processor, the program including instructions for:
receiving the recording command from the input module;
receiving an authentication code from the server via the communication module;
generating the physical outputs by the output module based on the authentication code;
generating the sensed data including the physical outputs from the environment by the sensing module;
sending by the communication module the sensed data including the physical outputs to the server while the sensing module generating the sensed data;
receiving a disconnecting command by the input module and disconnecting to the server accordingly; and
wherein the data will recorded as a recorded file in the server after the electronic device disconnecting to the server.

28. The electronic device according to claim 27, wherein the program further comprises instructions for:
buffering the sensed data in the storage module while the electronic device being disconnected with the server; and
sending the buffered data upon connecting to the server.

29. The electronic device according to claim 27, wherein the electronic device further comprises a display module, and the program further comprises instructions for:
sending by the communication module a download request to the server according to a download command received from the input module;
receiving by the communication module a download address generated corresponding to the recorded file from the server; and
displaying the download address on the display module.

30. The electronic device according to claim 27, wherein the output module includes a speaker for generating audio outputs as the physical output, and the sensing module includes a microphone for receiving sounds including the audio outputs from the environment and generating audio data as the sensed data.

31. The electronic device according to claim 27, wherein the output module includes a lighting unit for generating optical outputs as the physical output, and the sensing module includes an image sensor for receiving images including the light outputs from the environment and generating video data as the sensed data.

32. The electronic device according to claim 27, wherein the authentication code defines at least one of the number, strength, frequency, start time, end time and duration of the physical outputs.

33. The electronic device according to claim 27, wherein the authentication code includes a timestamp.
